(19) United States
(12) Patent Application Publication
(10) Pub. No.: US 2016/0037172 A1
(43) Pub. Date: Feb. 4, 2016

(54) IMAGE ENCODING METHOD, IMAGE DECODING METHOD, IMAGE ENCODING APPARATUS, IMAGE DECODING APPARATUS, IMAGE ENCODING PROGRAM, AND IMAGE DECODING PROGRAM

(71) Applicant: NIPPON TELEGRAPH AND TELEPHONE CORPORATION, Tokyo (JP)

(72) Inventors: Shinya SHIMIZU, Yokosuka-shi (JP); Shiori SUGIMOTO, Yokosuka-shi (JP); Hideaki KIMATA, Yokosuka-shi (JP); Akira KOJIMA, Yokosuka-shi (JP)

(73) Assignee: NIPPON TELEGRAPH AND TELEPHONE CORPORATION, Tokyo (JP)

(21) Appl. No.: 14/782,050

(22) PCT Filed: Apr. 7, 2014
(86) PCT No.: PCT/JP2014/060116

§ 371 Date: Oct. 2, 2015

(30) Foreign Application Priority Data
Apr. 11, 2013 (JP) 2013-082956

(51) Int. Cl. H04N 19/172; H04N 19/176; H04N 19/44; H04N 19/597

(52) U.S. Cl. CPC H04N 19/172; H04N 19/597; H04N 19/176; H04N 19/44

(57) ABSTRACT

The image encoding apparatus encodes while predicting an image between different views using a reference image encoded for a view different from a processing target image, and a reference depth map for an object of the reference image when a multiview image of plural different views is encoded. A view-synthesized image is generated for the entire encoding target image using the reference image and the reference depth map. A setting section sets whether to perform prediction for each of encoding target blocks into which the encoding target image is divided, or to perform prediction using the view-synthesized image for the entire encoding target image. Information is encoded to indicate the prediction unit. An encoding section performs predictive encoding on the encoding target image for every encoding target block, while selecting a predicted image generation method when the prediction for every encoding target block as the prediction unit has been selected.

### TECHNICAL FIELD

The present invention relates to an image encoding method, an image decoding method, an image encoding apparatus, an image decoding apparatus, an image encoding program, and an image decoding program for encoding and decoding a multiview image.

Priority is claimed on Japanese Patent Application No. 2013-82956, filed Apr. 11, 2013, the content of which is incorporated herein by reference.

### BACKGROUND ART

Conventionally, multiview images each including a plurality of images obtained by photographing the same object and background using a plurality of cameras are known. A moving image captured by the plurality of cameras is referred to as a “multiview moving image (or multiview video).” In the following description, an image (moving image) captured by one camera is referred to as a “two-dimensional image (moving image),” and a group of two-dimensional images (two-dimensional moving images) obtained by photographing the same object and background using a plurality of cameras differing in a position and/or direction (hereinafter referred to as a view) is referred to as a “multiview image (multiview moving image).”

A two-dimensional moving image has a high correlation in relation to a time direction and coding efficiency can be improved using the correlation. On the other hand, when cameras are synchronized, frames (images) corresponding to the same time of videos of the cameras in a multiview image or a multiview moving image are frames (images) obtained by photographing the object and background in completely the same state from different positions, and thus there is a high correlation between the cameras (different two-dimensional images of the same time). It is possible to improve coding efficiency by using the correlation in coding of a multiview image or a multiview moving image.

Here, conventional technology relating to encoding technology of two-dimensional moving images will be described. In many conventional two-dimensional moving-image encoding schemes including H.264, MPEG-2, and MPEG-4, which are international coding standards, highly efficient encoding is performed using technologies of motion-compensated prediction, orthogonal transform, quantization, and entropy coding. For example, in H.264, encoding using a temporal correlation with a plurality of past or future frames is possible.

Details of the motion-compensated prediction technology used in H.264, for example, are disclosed in Non-Patent Document 1. An outline of the motion-compensated prediction technology used in H.264 will be described. The motion-compensated prediction of H.264 enables an encoding target frame to be divided into blocks of various sizes and enable the blocks to have different motion vectors and different reference images. Using a different motion vector in each block, highly precise prediction which compensates for a different motion of a different object is realized. On the other hand, prediction having high precision considering occlusion caused by a temporal change is realized by using a different reference frame in each block.

Next, a conventional encoding scheme for multiview images or multiview moving images will be described. A difference between the multiview image coding scheme and the multiview moving-image coding scheme is that a correlation in the time direction is simultaneously present in a multiview moving image in addition to the correlation between the cameras. However, the same method using the correlation between the cameras can be used in both cases. Therefore, a method to be used in encoding multiview moving images will be described here.

In order to use the correlation between the cameras in the coding of multiview moving images, there is a conventional scheme of encoding a multiview moving image with high efficiency through “disparity-compensated prediction” in which the motion-compensated prediction is applied to images captured by different cameras at the same time. Here, the disparity is a difference between positions at which the same portion on an object is present on image planes of cameras arranged at different positions. FIG. 21 is a conceptual diagram illustrating the disparity occurring between the cameras. In the conceptual diagram illustrated in FIG. 21, image planes of cameras having parallel optical axes face down vertically. In this manner, the positions at which the same portion on the object are projected on the image planes of the different cameras are generally referred to as a corresponding point.

In the disparity-compensated prediction, each pixel value of an encoding target frame is predicted from a reference frame based on the corresponding relationship, and prediction residual thereof and disparity information representing the corresponding relationship are encoded. Because the disparity varies for every pair of target cameras and positions of the target cameras, it is necessary to encode disparity information for each region in which the disparity-compensated prediction is performed. Actually, in the multiview moving-image encoding scheme of H.264, a vector representing the disparity information is encoded for each block using the disparity-compensated prediction.

The corresponding relationship provided by the disparity information can be represented as a one-dimensional amount representing a three-dimensional position of an object, rather than a two-dimensional vector, based on epipolar geometric constraints by using camera parameters. Although there are various representations of information representing a three-dimensional position of the object, the distance from a reference camera to the object or coordinate values on an axis which is not parallel to an image plane of the camera is normally used. The reciprocal of the distance may be used instead of the distance. In addition, because the reciprocal of the distance is information proportional to the disparity, two reference cameras may be set and a three-dimensional position may be represented as the amount of disparity between images captured by the cameras. Because there is no essential difference regardless of what expression is used, information representing three-dimensional positions is hereafter expressed as a depth without such expressions being distinguished.

FIG. 22 is a conceptual diagram of epipolar geometric constraints. According to the epipolar geometric constraints, a point on an image of another camera corresponding to a point on an image of a certain camera is constrained to a straight line called an epipolar line. At this time, when a depth for a pixel of the image is obtained, a corresponding point is uniquely defined on the epipolar line. For example, as illustrated in FIG. 22, a corresponding point in an image of a second camera for the object projected at a position m in an image of a first camera is projected at a position m′ on the epipolar line when the position of the object in a real space is M′ and projected at a position m″ on the epipolar line when the position of the object in the real space is M″.

In Non-Patent Document 2, by using this property, highly precise prediction and efficient multiview moving-image coding are realized by generating a synthesized image for an encoding target frame from a reference frame and designating the generated synthesized image as a candidate for a predicted image for each region according to three-dimensional information of each object given by a depth map (distance image) for the reference frame. Also, the synthesized image generated based on the depth is referred to as a view-synthesized image, a view-interpolated image, or a disparity-compensated image.

Further, in Non-Patent Document 3, it is possible to generate a view-synthesized image only for a necessary region even while a depth map for the reference frame is used by generating a virtual depth map for an encoding target frame from a depth map for a reference frame for every region and obtaining a corresponding point using the generated virtual depth map.

### PRIOR ART DOCUMENT

### Non-Patent Document

Non-Patent Document 1: ITU-T Recommendation H.264 (March 2009), “Advanced video coding for generic audiovisual services,” March 2009.
Non-Patent Document 2: S. Shimizu, H. Kimata, and Y. Ohtani, “Adaptive appearance compensated view synthesis prediction for Multiview Video Coding,” In Proceedings of 16th IEEE International Conference on Image Processing (ICIP), pp. 2949-2952, 7-10 Nov. 2009.
Non-Patent Document 3: S. Shimizu, S. Sugimoto, and H. Kimata, “CE1.h: Backward Projection based View Synthesis Prediction using Derived Disparity Vector,” JCT-3V Input Contribution, JCT3V-00100, January 2013.

### SUMMARY OF INVENTION

### Problems to be Solved by the Invention

According to a method disclosed in Non-Patent Literature 2, it is possible to implement highly efficient prediction through a view-synthesized image on which highly precise disparity compensation has been performed using three-dimensional information of an object obtained from the depth map. In addition, even when a view-synthesized image having partially low precision is generated due to the quality of a depth map or influence of occlusion by selecting existing prediction and prediction using the view-synthesized image for every region, it is possible to prevent the code amount from increasing by selecting whether to set the view-synthesized image as a predicted image for every region.

However, in the method disclosed in Non-Patent Literature 2, there is a problem in that a processing load or memory usage increases because a view-synthesized image for one frame should be generated and stored regardless of whether to use the view-synthesized image as a predicted image. In addition, although a high-quality view-synthesized image is obtained for a wide region of a processing target image when a disparity between a processing target image (an encoding target image or a decoding target image) and a reference frame is small, when the quality of a depth map is high, or the like, there is also a problem in that a code amount increases because information indicating whether the view-synthesized image has been used as a predicted image should be encoded for every region.

On the other hand, because it is unnecessary to generate a view-synthesized image for a region which has not been used for prediction using the method of Non-Patent Literature 3, it is possible to solve the problem of the processing load and the memory usage.

However, there is a problem in that a code amount increases as compared with that of Non-Patent Literature 2 because the quality of a virtual depth map is generally lower than that of an accurate depth map and the quality of a generated view-synthesized image is also low. In addition, it is difficult to solve the problem of an increase of a code amount due to encoding of information indicating whether the view-synthesized image has been used as a predicted image for every region.

The present invention has been made in view of such circumstances, and an objective of the invention is to provide an image encoding method, an image decoding method, an image encoding apparatus, an image decoding apparatus, an image encoding program, and an image decoding program capable of implementing encoding with a small code amount while suppressing an increase in a processing amount and memory usage when a multiview moving image is encoded or decoded using a view-synthesized image as one of the predicted images.

### Means for Solving the Problems

According to the present invention, there is provided an image encoding apparatus for performing encoding while predicting an image between different views using a reference image encoded for a different view from an encoding target image and a reference depth map for an object of the reference image when a multiview image including images of a plurality of different views is encoded, the image encoding apparatus including: a view-synthesized image generating section configured to generate a view-synthesized image for the entire encoding target image using the reference image and the reference depth map; a prediction unit setting section configured to select whether to perform prediction for each of encoding target blocks into which the encoding target image is divided as a prediction unit or whether to perform prediction using the view-synthesized image for the entire encoding target image as the prediction unit; a prediction unit information encoding section configured to encode information indicating the selected prediction unit; and a predictive encoding target image encoding section configured to perform predictive encoding on the encoding target image for every encoding target block while selecting a predicted image generation method when the prediction for every encoding target block as the prediction unit has been selected.

The image encoding apparatus of the present invention may further include: a view-synthesized predictive residue encoding section configured to encode a difference between the encoding target image and the view-synthesized image when the prediction using the view-synthesized image for the entire encoding target image as the prediction unit has been selected.

The image encoding apparatus of the present invention may further include: an image unit prediction rate distortion (RD) cost estimating section configured to estimate an image unit prediction RD cost which is an RD cost when the entire encoding target image is predicted by the view-synthesized image and encoded; and a block unit prediction RD cost estimating section configured to estimate a block unit prediction RD cost which is an RD cost when the predictive encoding is performed on the encoding target image while selecting the predicted image generation method for every encoding target block, wherein the prediction unit setting section may compare the image unit prediction RD cost with the block unit prediction RD cost to set the prediction unit.

The image encoding apparatus of the present invention may further include: a partial view-synthesized image generating section configured to generate a partial view-synthesized image which is a view-synthesized image for the encoding target block using the reference image and the reference depth map for every encoding target block, wherein the predictive encoding target image encoding section may use the partial view-synthesized image as a candidate for a predicted image.

The image encoding apparatus of the present invention may further include: a prediction information generating section configured to generate prediction information for every encoding target block when the prediction using the view-synthesized image for the entire image as the prediction unit has been selected.

In the image encoding apparatus of the present invention, the prediction information generating section may determine a prediction block size, and the view-synthesized image generating section may generate the view-synthesized image for the entire encoding target image by iterating a process of generating the view-synthesized image for every prediction block size.

In the image encoding apparatus of the present invention, the prediction information generating section may estimate a disparity vector and generate prediction information as disparity-compensated prediction.

In the image encoding apparatus of the present invention, the prediction information generating section may determine a prediction method and generate prediction information for the prediction method.

According to the present invention, there is provided an image decoding apparatus for performing decoding while predicting an image between different views using a reference image decoded for a different view from the decoding target image and a reference depth map for an object of the reference image when the decoding target image is decoded from encoded data of a multiview image including images of a plurality of different views, the image decoding apparatus including: a view-synthesized image generating section configured to generate a view-synthesized image for the entire decoding target image using the reference image and the reference depth map; a prediction unit information decoding section configured to decode information about a prediction unit indicating whether to perform prediction for each of decoding target blocks into which the decoding target image has been divided, or whether to perform prediction using the view-synthesized image for the entire decoding target image, from the encoded data; a decoding target image setting section configured to set the view-synthesized image as the decoding target image when the information about the prediction unit indicates that the prediction is performed using the view-synthesized image for the entire decoding target image; and a decoding target image decoding section configured to decode the decoding target image from the encoded data while generating a predicted image for every decoding target block when the information about the prediction unit indicates that the prediction is performed for every decoding target block.

In the image decoding apparatus of the present invention, the decoding target image setting section may decode a difference between the decoding target image and the view-synthesized image from the encoded data and generate the decoding target image by adding the difference to the view-synthesized image.

The image decoding apparatus of the present invention may further include: a partial view-synthesized image generating section configured to generate a partial view-synthesized image which is a view-synthesized image for the decoding target block using the reference image and the reference depth map for every decoding target block, wherein the decoding target image decoding section may use the partial view-synthesized image as a candidate for a predicted image.

The image decoding apparatus of the present invention may further include: a prediction information generating section configured to generate prediction information for every decoding target block when the information about the prediction unit indicates that the prediction is performed using the view-synthesized image for the entire decoding image.

In the image decoding apparatus of the present invention, the prediction information generating section may determine a prediction block size, and the view-synthesized image generating section may generate the view-synthesized image for the entire decoding target image by iterating a process of generating the view-synthesized image for every prediction block size.

In the image decoding apparatus of the present invention, the prediction information generating section may estimate a disparity vector and generates prediction information as disparity-compensated prediction.

In the image decoding apparatus of the present invention, the prediction information generating section may determine a prediction method and generate prediction information for the prediction method.

According to the present invention, an image encoding method is provided for performing encoding while predicting an image between different views using a reference image encoded for a different view from an encoding target image and a reference depth map for an object of the reference image when a multiview image including images of a plurality of different views is encoded, the image encoding method including: a view-synthesized image generating step of generating a view-synthesized image for the entire encoding target image using the reference image and the reference depth map; a prediction unit setting step of selecting whether to perform prediction for each of encoding target blocks into which the encoding target image is divided as a prediction unit or whether to perform prediction using the view-synthesized image for the entire encoding target image as the prediction unit; a prediction unit information encoding step of encoding information indicating the selected prediction unit; and a predictive encoding target image encoding step of performing predictive encoding on the encoding target image for every encoding target block while selecting a predicted image generation method when the prediction for every encoding target block as the prediction unit has been selected.

According to the present invention, an image decoding method is provided for performing decoding while predicting an image between different views using a reference image decoded for a different view from the decoding target image and a reference depth map for an object of the reference image when the decoding target image is decoded from encoded data of a multiview image including images of a plurality of different views, the image decoding method including: a view-synthesized image generating step of generating a view-synthesized image for the entire decoding target image using the reference image and the reference depth map; a prediction unit information decoding step of decoding information about a prediction unit indicating whether to perform prediction for each of decoding target blocks into which the decoding target image has been divided, or whether to perform prediction using the view-synthesized image for the entire decoding target image, from the encoded data; a decoding target image setting step of setting the view-synthesized image as the decoding target image when the information about the prediction unit indicates that the prediction is performed using the view-synthesized image for the entire decoding target image; and a decoding target image decoding step of decoding the decoding target image from the encoded data while generating a predicted image for every decoding target block when the information about the prediction unit indicates that the prediction is performed for every decoding target block.

According to the present invention, an image encoding program is provided for causing a computer to execute the image encoding method.

According to the present invention, there is provided an image decoding program for causing a computer to execute the image decoding method.

According to one aspect of the present invention, a computer-readable recording medium is provided for recording the image encoding program.

According to another aspect of the present invention, a computer-readable recording medium is provided for recording the image decoding program.

### Advantageous Effects of the Invention

According to the present invention, there is an advantageous effect in that it is possible to encode a multiview image and a multiview moving image with a small code amount without increasing a calculation amount and memory usage by adaptively switching prediction for the entire encoding target image and prediction of an encoding target block unit when a view-synthesized image is used as one of predicted images.

### BRIEF DESCRIPTION OF DRAWINGS

FIG. 1 is a block diagram illustrating an image encoding apparatus according to a first embodiment of the present invention.

FIG. 2 is a flowchart illustrating an operation of the image encoding apparatus illustrated in FIG. 1.

FIG. 3 is a flowchart illustrating another operation of the image encoding apparatus illustrated in FIG. 1.

FIG. 4 is a block diagram illustrating an image encoding apparatus according to a second embodiment of the present invention.

FIG. 5 is a flowchart illustrating an operation of the image encoding apparatus illustrated in FIG. 4.

FIG. 6 is a flowchart illustrating another operation of the image encoding apparatus illustrated in FIG. 4.

FIG. 7 is a block diagram illustrating an image encoding apparatus according to a third embodiment of the present invention.

FIG. 8 is a block diagram illustrating an image encoding apparatus according to a fourth embodiment of the present invention.

FIG. 9 is a flowchart illustrating a processing operation of constructing/outputting a bitstream of frame unit prediction in the image encoding apparatus illustrated in FIGS. 7 and 8.

FIG. 10 is a block diagram illustrating an image decoding apparatus according to a fifth embodiment of the present invention.

FIG. 11 is a flowchart illustrating an operation of the image decoding apparatus illustrated in FIG. 10.

FIG. 12 is a flowchart illustrating another operation of the image decoding apparatus illustrated in FIG. 10.

FIG. 13 is a block diagram illustrating an image decoding apparatus according to a sixth embodiment of the present invention.

FIG. 14 is a flowchart illustrating an operation of the image decoding apparatus illustrated in FIG. 13.

FIG. 15 is a block diagram illustrating an image decoding apparatus according to a seventh embodiment of the present invention.

FIG. 16 is a block diagram illustrating an image decoding apparatus according to an eighth embodiment of the present invention.

FIG. 17 is a flowchart illustrating an operation of the image decoding apparatus illustrated in FIG. 15.

FIG. 18 is a flowchart illustrating an operation of the image decoding apparatus illustrated in FIG. 16.

FIG. 19 is a block diagram illustrating an image encoding apparatus according to a ninth embodiment of the present invention.

FIG. 20 is a block diagram illustrating an image decoding apparatus according to a tenth embodiment of the present invention.

FIG. 21 is a conceptual diagram of disparity which occurs between two cameras.

FIG. 22 is a conceptual diagram of epipolar geometric constraints.

### EMBODIMENTS FOR CARRYING OUT THE INVENTION

Hereinafter, an image encoding apparatus and an image decoding apparatus according to embodiments of the present invention will be described with reference to the drawings. In the following description, the case in which a multiview image captured by a first camera (referred to as camera A) and a second camera (referred to as camera B) is encoded is assumed and an image of the camera B is described as being encoded or decoded by designating an image of the camera A as a reference image.

Also, information necessary for obtaining a disparity from depth information is assumed to have been separately provided. Specifically, although this information is an external parameter representing a positional relationship of the cameras A and B or an internal parameter representing projection information for an image plane of the camera, other information may be provided when a disparity is obtained from the depth information, even in other forms. Detailed description relating to these camera parameters, for example, is disclosed in Reference Literature <Olivier Faugeras, “Three-Dimensional Computer Vision,” MIT Press; BCTC/UFF-006.37 F259 1993, ISBN: 0-262-06158-9.>. In this literature, description relating to a parameter representing a positional relationship of a plurality of cameras or a parameter representing projection information for an image plane of a camera is disclosed.

In the following description, information (coordinate values or an index capable of corresponding to the coordinate values) capable of specifying a position added between brackets [ ] to an image or video frame or a depth map is assumed to represent an image signal sampled depending on a pixel of the same position or a depth corresponding to the image signal. In addition, a coordinate value or a block of a position obtained by shifting coordinates or a block by an amount of a vector is assumed to be represented by the addition of an index value capable of corresponding to coordinate values or a block to a vector.

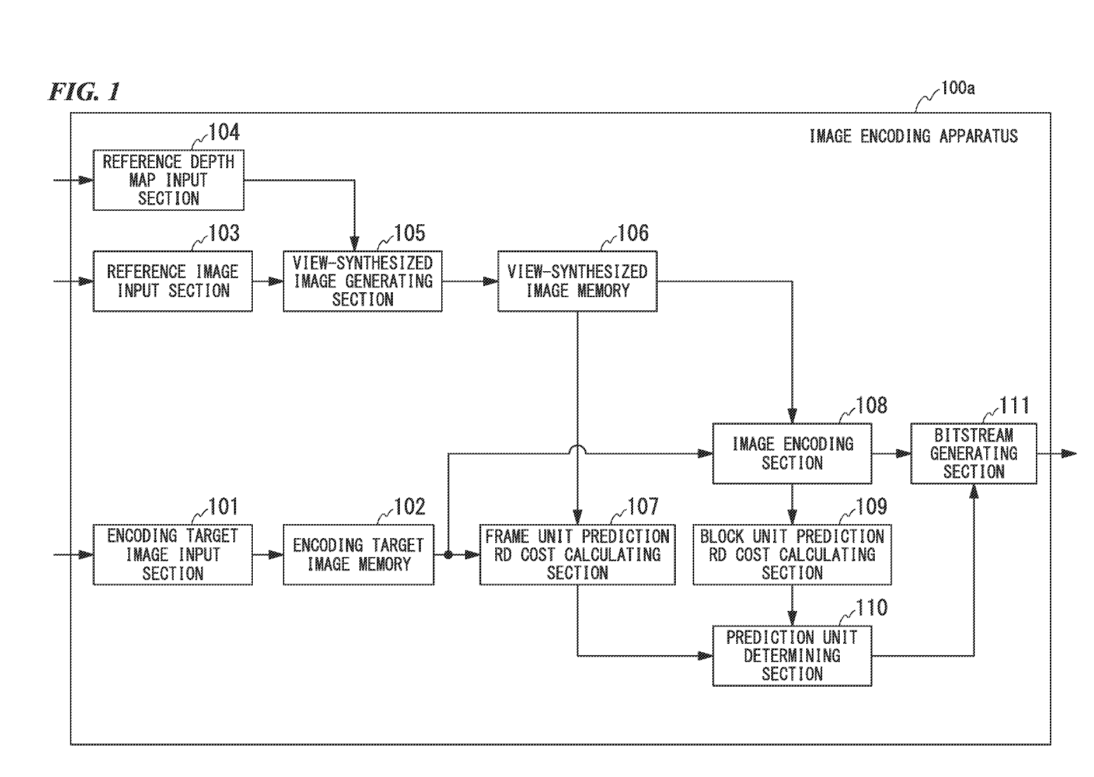

FIG. 1 is a block diagram illustrating a configuration of an image encoding apparatus according to a first embodiment of the present invention. As illustrated in FIG. 1, the image encoding apparatus 100a includes an encoding target image input section 101, an encoding target image memory 102, a reference image input section 103, a reference depth map input section 104, a view-synthesized image generating section 105, a view-synthesized image memory 106, a frame unit prediction RD cost calculating section 107, an image encoding section 108, a block unit prediction RD cost calculating section 109, a prediction unit determining section 110, and a bitstream generating section 111.

The encoding target image input section 101 inputs an image serving as an encoding target. Hereinafter, the image serving as the encoding target is referred to as an encoding target image. Here, the image of the camera B is assumed to be input. In addition, a camera (here, the camera B) capturing the encoding target image is referred to as an encoding target camera. The encoding target image memory 102 stores the input encoding target image. The reference image input section 103 inputs an image to be referenced when the view-synthesized image (disparity-compensated image) is generated. Hereinafter, the image input here is referred to as a reference image. Here, an image of the camera A is assumed to be input.

The reference depth map input section 104 inputs a depth map to be referenced when a view-combined image is generated. Here, although the depth map for the reference image is assumed to be input, the depth map for another camera may also be input. Hereinafter, this depth map is referred to as a reference depth map. Also, a depth map indicates a three-dimensional position of the object mirrored in each pixel of a corresponding image. As long as the three-dimensional position is obtained by information of a separately provided camera parameter or the like, any information may be used. For example, it is possible to use a distance from the camera to the object or coordinate values for an axis which is not parallel to an image plane and a disparity amount for another camera (for example, camera B). In addition, because it is only necessary to obtain a disparity amount here, a disparity map directly representing the disparity amount may be used instead of a depth map. In addition, although the depth map is provided in the form of an image here, the depth map may not be configured in the form of an image as long as similar information can be obtained. Hereinafter, a camera (here, the camera A) corresponding to the reference depth map is referred to as a reference depth camera.

The view-synthesized image generating section 105 obtains a corresponding relationship between a pixel of an encoding target image and a pixel of a reference image using a reference depth map and generates a view-synthesized image for an encoding target image. The view-synthesized image memory 106 stores the generated view-synthesized images for the encoding target image.

The frame unit prediction RD cost calculation section 107 calculates an RD cost when the encoding target image has been predicted in units of frames using the view-synthesized image. The image encoding section 108 performs predictive encoding on the encoding target image in units of blocks using the view-synthesized image. The block unit prediction RD cost calculating section 109 calculates an RD cost when predictive encoding has been performed on the encoding target image in units of blocks using the view-synthesized image. The prediction unit determining section 110 determines whether to predict the encoding target image in units of frames or perform predictive encoding in units of blocks based on the RD cost. The bitstream generating section 111 constructs and outputs the bitstream for the encoding target image based on the determination of the prediction unit determining section 110.

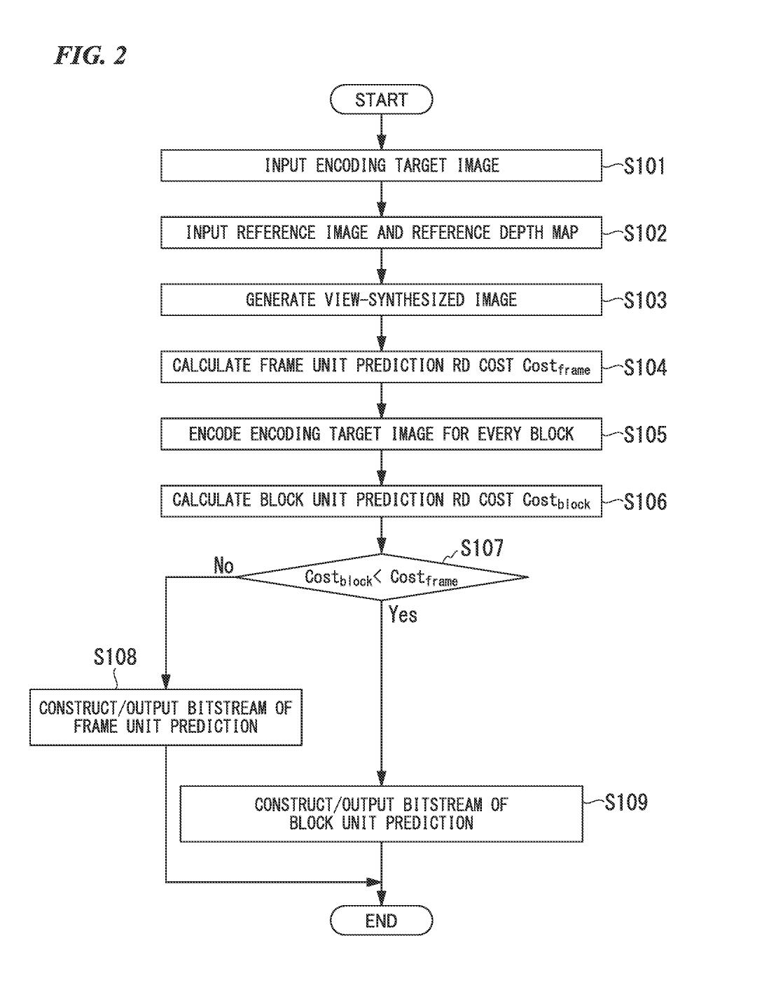

Next, an operation of the image encoding apparatus 100a illustrated in FIG. 1 will be described with reference to FIG. 2. FIG. 2 is a flowchart illustrating an operation of the image encoding apparatus 100a illustrated in FIG. 1. First, the encoding target image input section 101 inputs an encoding target image Org and stores the encoding target image Org in the encoding target image memory 102 (step S101). Next, the reference image input section 103 inputs a reference image and the reference depth map input section 104 inputs a reference depth map and outputs the reference depth map to the view-synthesized image generating section 105 (step S102).

Also, the reference image and the reference depth map input in step S102 are assumed to be the same as those to be obtained on the decoding side such as the reference image and the reference depth map obtained by decoding the already encoded reference image and reference depth map. This is because the occurrence of encoding noise such as a drift is suppressed by using exactly the same information as that obtained by the decoding apparatus. However, when this occurrence of encoding noise is allowed, content obtained on only the encoding side such as content before encoding may be input. In relation to the reference depth map, a depth map estimated by applying stereo matching or the like to a multiview image decoded for a plurality of cameras, a depth map estimated using a decoded disparity vector, a motion vector or the like, and so on may be used as a depth map to be equally obtained on the decoding side in addition to content obtained by decoding already encoded content.

Next, the view-synthesized image generating section 105 generates a view-synthesized image Synth for the encoding target image and stores the view-synthesized image Synth in the view-synthesized image memory 106 (step S103). The process here may use any method of synthesizing an image in an encoding target camera using a reference image and a reference depth map. For example, a method disclosed in Non-Patent Literature 2 or Literature <Y. Mori, N. Fukushima, T. Fuji, and M. Tanimoto, “View Generation with 3D Warping Using Depth Information for FTV,” In Proceedings of 3DTV-CON2008, pp. 229 to 232, May 2008.> may be used.

Next, when the view-synthesized image is obtained, the frame unit prediction RD cost calculation section 107 calculates an RD cost when the entire encoding target image is predicted in a view-synthesized image and encoded (step S104). The RD cost is a value indicated by a weighted sum of a generated code amount and distortion caused due to encoding as shown in the following Formula (1).

Costₘ=Dₘ+λ·Rₘ (1)

In Formula (1), Costₘ is the RD cost, Dₘ is a distortion amount from the encoding target image of an image obtained from an encoding result (more exactly, a decoded image to be obtained by decoding a bitstream of an encoding result), Rₘ is a code amount of the bitstream obtained from the encoding result, and λ is a Lagrange undetermined multiplier depending on a target bit rate, target quality, or the like. Also, any measure as the distortion amount may be used. For example, it is possible to use a measure indicating signal distortion such as a sum of squared differences (SSD) or a sum of absolute differences (SAD), or a distortion measure related to subjective quality such as structural similarity (SSIM).

In Formula (1), m indicates a technique used in encoding and “frame” is assumed to indicate an encoding technique by prediction in units of frames using a view-synthesized image. Any method in which information indicating generation or selection of a predicted image in each region is not encoded may be used as the encoding technique by the prediction in the units of frames using the view-synthesized image.

Here, although the case in which a method of skipping encoding of an encoding target image by using a decoding result for the encoding target image as a view-synthesized image and setting information indicating the skipping as the encoding result is used has been described, another method such as a method of performing conversion encoding on a predictive residue of the encoding target image for every frame or region using the predicted image as the view-synthesized image in the entire encoding target image may be used.

A distortion amount D_{frame} when a method of skipping the encoding of the encoding target image by using the decoding result for the encoding target image as the view-synthesized image if the distortion amount is indicated by the SSD and setting the information indicating that the skipping has been performed as an encoding result is used is expressed by the following Formula (2).

D_{frame}=Σₚ(Org[p]−Synth[p])² (2)

Also, p is an index indicating a pixel position and Σₚ indicates a sum for all pixels within the encoding target image.

Because the information indicating the skipping can be indicated by a flag of whether the skipping has been performed, its code amount R_{frame} is set as one bit here. Also, a flag of a length of one or more bits may be used or a code amount less than 1 bit may be used by performing entropy encoding along with a flag for another frame.

Next, the image encoding section 108 performs encoding while generating a predicted image for each of the regions (encoding target blocks) into which the encoding target image has been divided (step S105). Any method of dividing an image and performing encoding for every block may be used as an encoding method. For example, a scheme based on H.264/AVC disclosed in Non-Patent Literature 1 may be used. Also, a scheme that uses or does not use a view-synthesized image as a candidate for a predicted image to be selected for every block may be used.

Next, when the encoding for every block is completed, the block unit prediction RD cost calculating section 109 divides the encoding target image into a plurality of blocks and calculates an RD cost Cost_{block} when encoding is performed while a prediction scheme is selected for every block (step S106). Here, the block unit prediction RD cost Cost_{block} is calculated according to Formula (1) using a distortion amount D_{block} for the encoding target image of an image of an encoding result (more exactly, a decoded image to be obtained by decoding a bitstream of an encoding result) in step S105 and a code amount R_{block} obtained by adding a code amount of a flag indicating that encoding of the encoding target image has not been skipped to a code amount of a bitstream of the encoding result in step S105.

Next, when two RD costs are obtained, the prediction unit determining section 110 determines a prediction unit by comparing the RD costs (step S107). Also, because the coding efficiency is indicated to be higher when a value of the RD cost defined in Formula (1) is smaller, the prediction unit having a smaller RD cost is selected. If the RD cost indicating that the coding efficiency is higher is used when the value is larger, it is necessary to reverse the determination and select the prediction unit having a higher RD cost.

When it is determined that prediction of a frame unit using the view-synthesized image is used (Cost_{block}<Cost_{frame} is not satisfied) as a determination result, the bitstream generating section 111 generates a bitstream when the frame unit prediction is performed (step S108). The generated bitstream becomes an output of the image encoding apparatus 100a. Here, a 1-bit flag indicating that the entire image to be decoded is a view-synthesized image becomes a bitstream in this case.

Also, when a scheme in which the predicted image is assumed to be the view-synthesized image in the entire encoding target image and conversion encoding is performed on a predictive residue of the encoding target image for every frame or block has been used as a scheme in which prediction of the frame unit using the view-synthesized image is used, a bitstream in which a bitstream corresponding to the predictive residue is connected to the above-described flag is generated. At this time, although the bitstream for the predictive residue may be newly generated, the bitstream generated in step S104 may be stored in a memory or the like so that the bitstream is read from the memory or the like for use. Thereby, it is possible to avoid a process of generating the bitstream for the predictive residue from being performed a plurality of times and reduce a calculation amount relating to encoding.

On the other hand, when it is determined that the prediction of the block unit is used (Cost_{block}<Costₙₐₘₑ is satisfied) as a determination result, the bitstream generating section 111 generates a bitstream when the block unit prediction is performed (step S109). The generated bitstream becomes an output of the image encoding apparatus 100a. Here, a bitstream in which the bitstream generated by the image encoding section 108 in step S105 is connected to a 1-bit flag indicating that the entire image to be decoded is not a view-synthesized image is generated. Also, the bitstream generated in step S105 may be prestored in a memory or the like to be read for use or the bitstream may be regenerated again.

Here, the image encoding apparatus 100a outputs the bitstream for an image signal. That is, a parameter set or header indicating information of an image size or the like is assumed to be separately added to the bitstream output by the image encoding apparatus 100a if necessary.

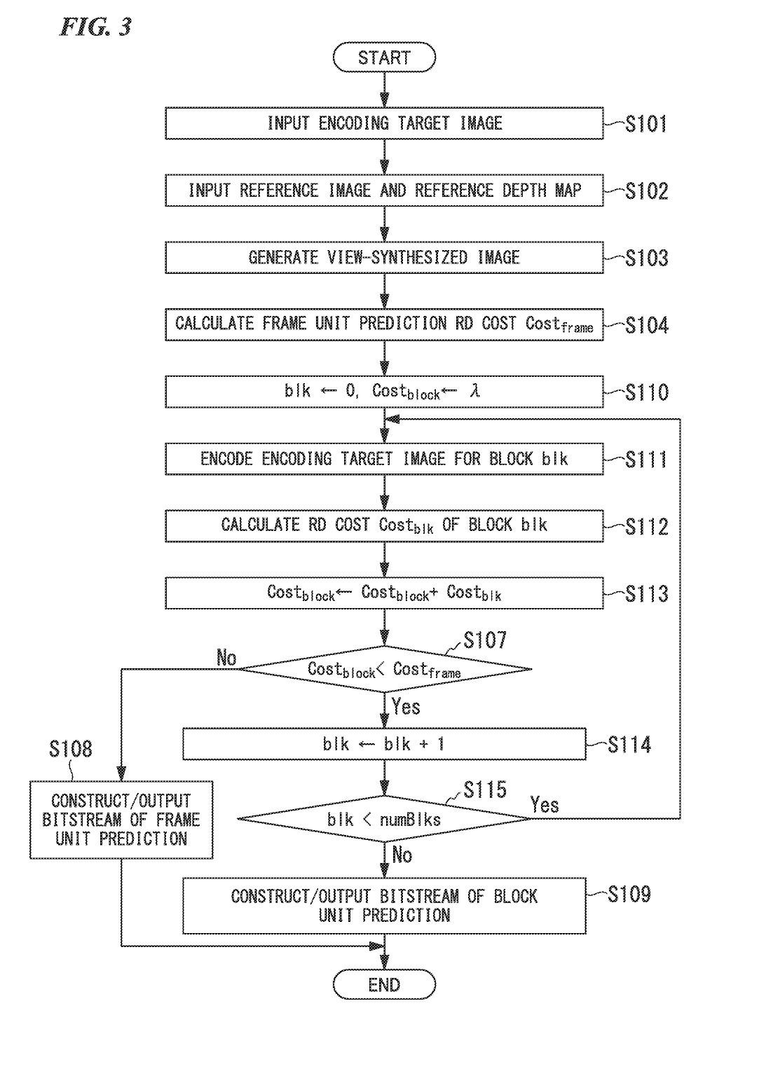

Although the determination of the prediction unit is made after encoding using the prediction of the block unit is performed on all blocks in the above description, the determination may be made every time a given number of blocks are encoded when the RD cost using the distortion amount and the code amount of the entire image is used. FIG. 3 is a flowchart illustrating a processing operation when the determination is made for every block as an example. A part for performing the same process as the processing operation illustrated in FIG. 2 is assigned the same reference sign and description thereof will be omitted.

The processing operation illustrated in FIG. 3 is different from the processing operation illustrated in FIG. 2 in that an encoding process, an RD cost calculation process, and a prediction unit determination process are iterated for every block after a frame unit prediction RD cost is calculated. That is, first, a variable blk indicating an index of each of the blocks into which the encoding target image is divided becomes zero, wherein the block is a unit in which an encoding process is performed, and the block unit prediction RD cost Cost_{block} is initialized to λ (step S110). Next, while the variable blk is incremented by 1 (step S114), the following process (steps S111 to S113 and step S107) is iterated until the variable blk reaches the number of blocks numBLks within the encoding target image (step S115). Also, although Cost_{block} has been initialized to λ in step S110, it is necessary to perform initialization to an appropriate value according to a bit amount of information indicating the prediction unit and a unit of a code amount when the RD cost is calculated. Here, it is assumed that the information indicating the prediction unit is 1 bit and the code amount in the RD cost calculation is in units of bits.

In a process to be performed on each of encoding target blocks into which the encoding target image has been divided, the image encoding section 108 first encodes the encoding target image for the block indicated by the variable blk (step S111). As long as decoding is able to be correctly performed on the decoding side, any method may be used in encoding

In general moving-image encoding or image encoding such as MPEG-2, H.264, or joint photographic experts group (JPEG), one mode among a plurality of prediction modes is selected for every block to generate a predicted image and frequency conversion such as a discrete cosine transform (DCT) is performed on a difference signal between an encoding target image and the predicted image. Next, encoding is performed by sequentially applying processes of quantization, binarization, and entropy encoding on a value obtained as a result of the frequency conversion. Also, in the encoding, the view-synthesized image may be used as one of the candidates for the predicted image.

Next, an RD cost Cost_{blk} for the block blk is calculated (step S112). A range of an image serving as a target is the only difference in the process here and the process is the same as that of the above-described step S106. That is, the RD cost Cost_{blk} for the block blk is calculated according to Formula (1) from the distortion amount D_{blk} (and the code amount R_{blk} of the block blk. Then, the RD cost for the block blk obtained through the calculation is added to Cost_{block} (step S113) and a prediction unit is determined by comparing Cost_{block} with Cost_{frame} (step S107).

At a point in time when Cost_{block} is greater than or equal to Cost_{frame}, it is determined that prediction of the frame unit is used and the process for every block ends. Also, because the determination is made for every block, it is determined that the prediction of the block unit is used without determining the prediction unit again when the process for all blocks has been completed.

Although the same view-synthesized image is used when the prediction of the frame unit is performed and when the prediction of the block unit is performed in the above description, view-synthesized images may be generated in different methods. For example, the memory amount for storing the view-synthesized image may be reduced and the quality of the view-synthesized image may be improved by referencing information of a previously encoded block to perform synthesis when the prediction is performed in units of blocks. In addition, when the prediction is performed in units of frames, the quality of a decoded image obtained on the decoding side may be improved by performing synthesis in view of the integrity or objective quality in the entire frame.

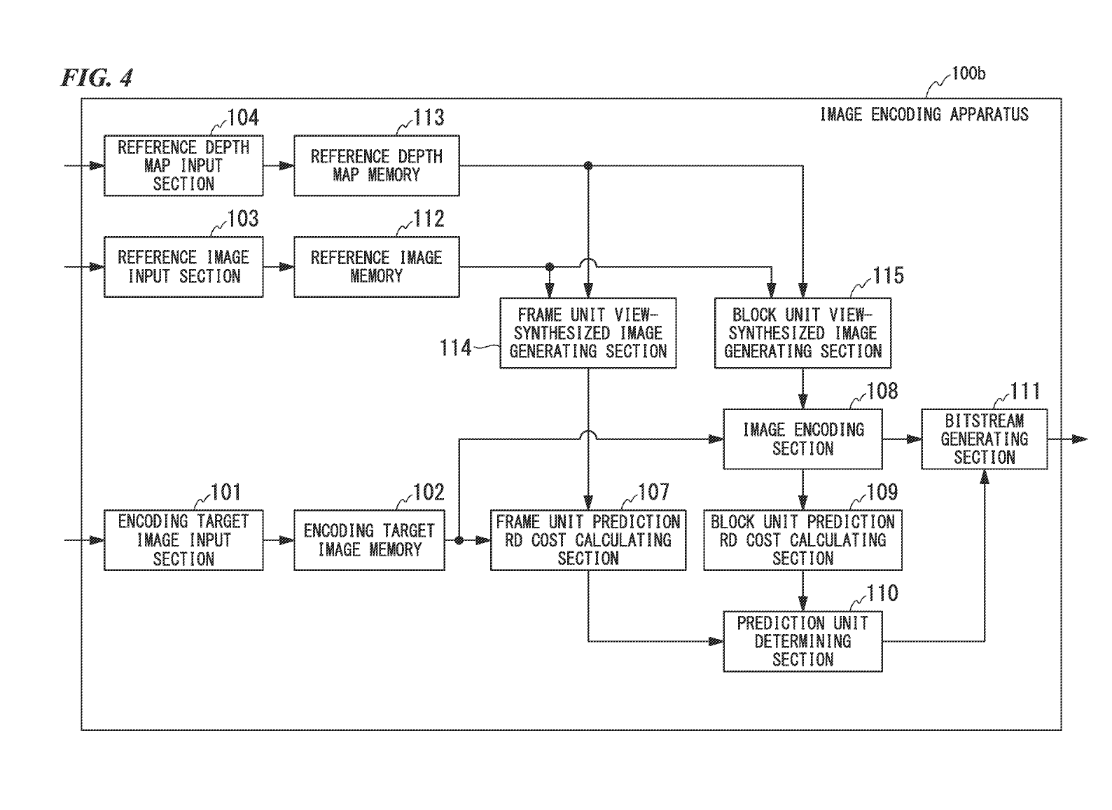

Next, an image encoding apparatus according to the second embodiment of the present invention will be described with reference to FIG. 4. FIG. 4 is a block diagram illustrating a configuration of the image encoding apparatus when a view-synthesized image is generated in a different method for every prediction unit. A difference between the image encoding apparatus 100a illustrated in FIG. 1 and the image encoding apparatus 100b illustrated in FIG. 4 is that the image encoding apparatus 100b has two view-synthesized image generating sections including a frame unit view-synthesized image generating section 114 and a block unit view-synthesized image generating section 115 and the view-synthesized image memory is not necessarily provided. Also, the same components as those of the image encoding apparatus 100a are assigned the same reference signs and description thereof will be omitted.

The frame unit view-synthesized image generating section 114 obtains a corresponding relationship between the pixel of the encoding target image and the pixel of the reference image using the reference depth map and generates a view-synthesized image for the entire encoding target image. The block unit view-synthesized image generating section 115 generates a view-synthesized image for every block on which an encoding process of the encoding target image is performed using the reference depth map.

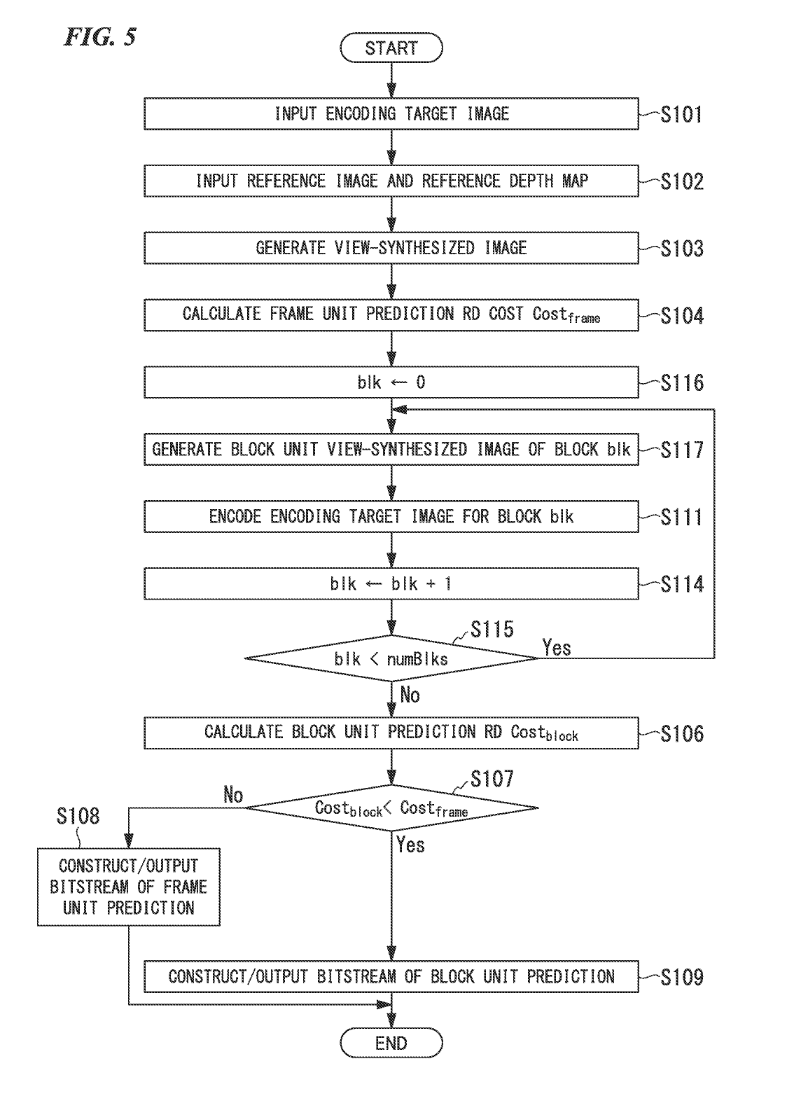

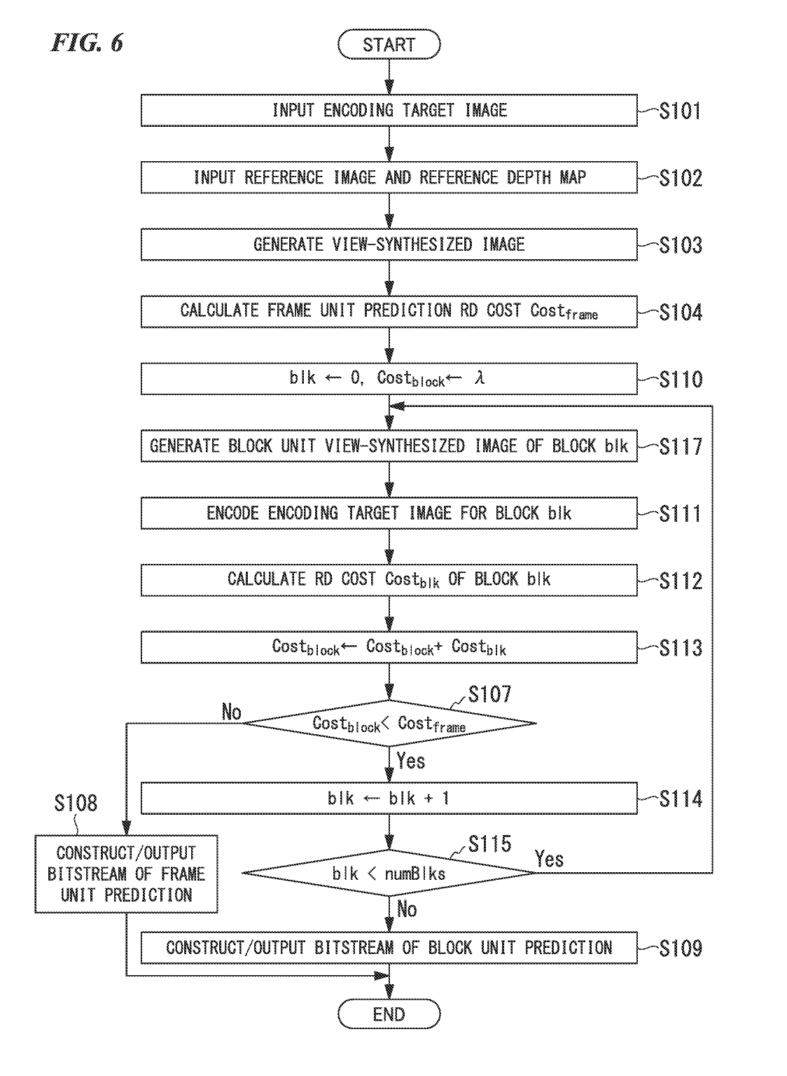

Next, an operation of the image encoding apparatus 100b illustrated in FIG. 4 will be described with reference to FIGS. 5 and 6.

FIGS. 5 and 6 are flowcharts illustrating the operation of the image encoding apparatus 100b illustrated in FIG. 4. FIG. 5 illustrates a processing operation when the determination of the prediction unit is made after encoding using the prediction of the block unit is performed on all blocks and FIG. 6 illustrates a processing operation when the encoding and the determination are iterated for every block. In FIG. 5 or 6, a part for performing the same process as that of the flowchart illustrated in FIG. 2 or 3 is assigned as the same reference sign and description thereof will be omitted.

In FIG. 5 or 6, a difference from the processing operation illustrated in FIG. 2 or 3 is that a process of generating a view-synthesized image for the block for every block in addition to a view-synthesized image generated for prediction in units of frames is performed (step S117). Also, any method as a process of generating a view-synthesized image for every block may be used. For example, a method disclosed in Non-Patent Literature 3 may be used.

Although only information indicating the prediction unit is generated for the entire encoding target image and no prediction information is generated for each block of the encoding target image when the prediction of the frame unit is performed in the above description, prediction information for each block which is not included in a bitstream may be generated and referenced when another frame is encoded. Here, the prediction information is information to be used for generation of a predicted image or decoding of a predictive residue such as a prediction block size or prediction mode and a motion/disparity vector.

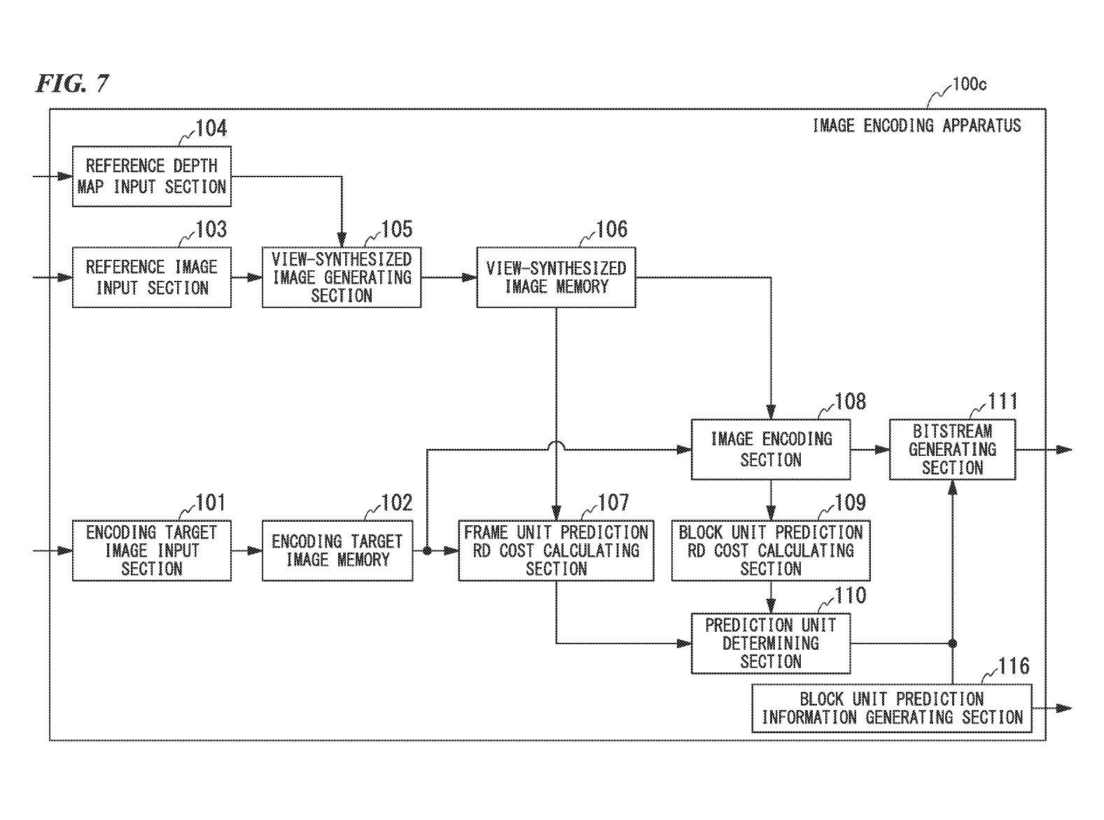

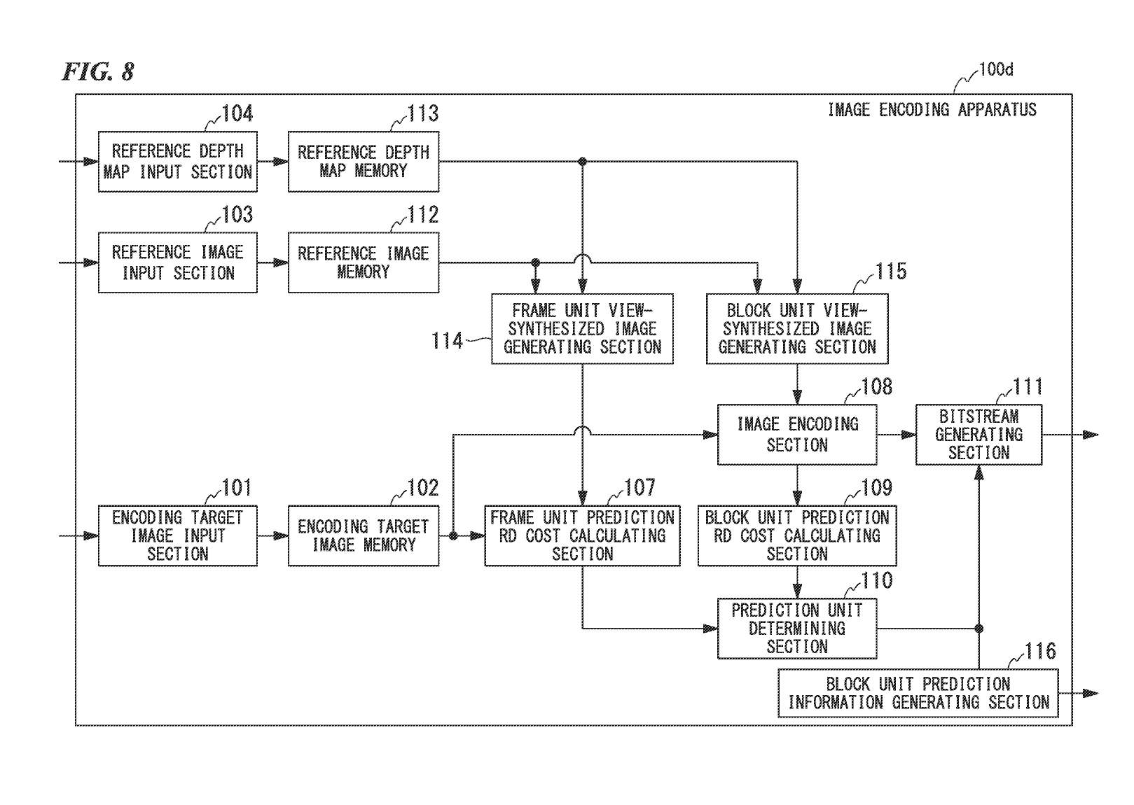

Next, the image encoding apparatuses according to the third and fourth embodiments of the present invention will be described with reference to FIGS. 7 and 8.

FIGS. 7 and 8 are block diagrams illustrating configurations of image encoding apparatuses in which prediction information is generated for each of the blocks into which an encoding target image can be divided and referenced when another frame is encoded if it is determined that the prediction of the frame unit is performed. In the block diagrams, the image encoding apparatus 100c illustrated in FIG. 7 corresponds to the image encoding apparatus 100a illustrated in FIG. 1 and the image encoding apparatus 100d illustrated in FIG. 8 corresponds to the image encoding apparatus 100b illustrated in FIG. 4. A difference in each block diagram is that a block unit prediction information generating section 116 is further included. Also, the same components are assigned the same reference signs and description thereof will be omitted.

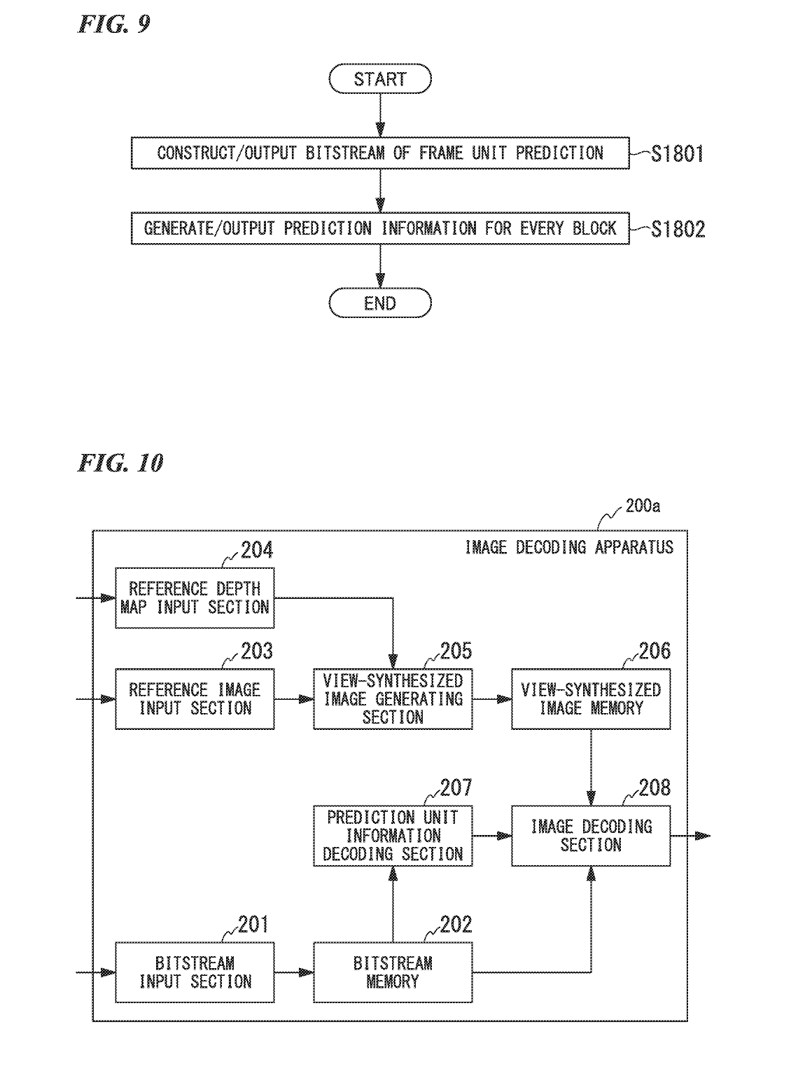

When it is determined that the prediction of the frame unit is performed, the block unit prediction information generating section 116 generates prediction information for each of the blocks into which the encoding target image is divided and outputs the generated prediction information to the image encoding apparatus for encoding another frame. Also, when another frame is encoded in the same image encoding apparatus, the generated information is passed to the image encoding section 108. Processing operations to be executed by the image encoding apparatus 100c illustrated in FIG. 7 and the image encoding apparatus 100d illustrated in FIG. 8 are basically the same as those described above, and processing operations illustrated in FIG. 9 are only executed in a process (step S108) of constructing/outputting the bitstream of the frame unit prediction.

FIG. 9 is a flowchart illustrating a processing operation of constructing/outputting a bitstream of frame unit prediction. First, the bitstream of the frame unit prediction is constructed/output (step S1801). This process is the same as the above-described step S108. Thereafter, in the block unit prediction information generating section 116, prediction information is generated/output for each of the blocks into which the encoding target image is divided (step S1802). As long as the decoding side can generate the same information, any information may be generated in the generation of the prediction information.

For example, a block size as large as possible or a block size as small as possible may be designated as a prediction block size. In addition, a different block size may be set for every block by making a determination based on the used depth map or the generated view-synthesized image. The block size may be adaptively determined so that a set of pixels as large as possible is provided, wherein the pixels have similar pixel values or depth values.

As the prediction mode or the motion/disparity vector, the mode information or motion/disparity vector indicating the prediction using the view-synthesized image may be set when the prediction is performed for every block with respect to all blocks. In addition, the mode information corresponding to an inter-view prediction mode and the disparity vector obtained from a depth or the like may be set as the mode information and the motion/disparity vector, respectively. The disparity vector may be obtained by performing a search on a reference image using the view-synthesized image for the block as a template.

As another method, an optimum block size or prediction mode may be estimated and generated by regarding the view-synthesized image as the encoding target image and analyzing the view-synthesized image. In this case, intra-picture prediction, motion-compensated prediction, or the like may be selected as the prediction mode.

In this manner, information which is not obtained from the bitstream can be generated and referenced when another frame is encoded, so that it is possible to improve coding efficiency in another frame. This is because there are correlations even in motion vectors or prediction modes when similar frames such as temporally continuous frames or frames obtained by photographing the same object are encoded and because redundancy can be removed using these correlations.

Next, an image decoding apparatus according to a fifth embodiment of the present invention will be described. FIG. 10 is a block diagram illustrating a configuration of the image decoding apparatus in this embodiment. As illustrated in FIG. 10, the image decoding apparatus 200a includes a bitstream input section 201, a bitstream memory 202, a reference image input section 203, a reference depth map input section 204, a view-synthesized image generating section 205, a view-synthesized image memory 206, a prediction unit information decoding section 207, and an image decoding section 208.

The bitstream input section 201 inputs a bitstream of an image serving as a decoding target. Hereinafter, the image serving as the decoding target is referred to as a decoding target image. Here, the image of the camera B is assumed to be input. In addition, a camera (here, the camera B) capturing the decoding target image is referred to as a decoding target camera. The bitstream memory 202 stores a bitstream for the input decoding target image. The reference image input section 203 inputs an image to be referenced when the view-synthesized image (disparity-compensated image) is generated. Hereinafter, the image input here is referred to as a reference image.

Here, an image of the camera A is assumed to be input.

The reference depth map input section 204 inputs a depth map to be referenced when a view-combined image is generated. Here, although the depth map for the reference image is assumed to be input, the depth map for another camera may also be input. Hereinafter, this depth map is referred to as a reference depth map. A depth map indicates a three-dimensional position of the object mirrored in each pixel of a corresponding image. As long as the three-dimensional position is obtained by information of a separately provided camera parameter or the like, any information may be used. For example, it is possible to use a distance from the camera to the object or coordinate values for an axis which is not parallel to an image plane and a disparity amount for another camera (for example, the camera B). In addition, because it is only necessary to obtain a disparity amount here, a disparity map directly representing the disparity amount may be used instead of a depth map. In addition, although the depth map is provided in the form of an image here, the depth map may not be configured in the form of an image as long as similar information can be obtained. Hereinafter, a camera (here, the camera A) corresponding to the reference depth map is referred to as a reference depth camera.

The view-synthesized image generating section 205 obtains a corresponding relationship between the pixel of the decoding target image and the pixel of the reference image using the reference depth map and generates a view-synthesized image for the decoding target image. The view-synthesized image memory 206 stores a view-synthesized image for the generated decoding target image. The prediction unit information decoding section 207 decodes information indicating whether the decoding target image is predicted in units of frames or whether predictive encoding is performed in units of blocks from the bitstream. The image decoding section 208 decodes the decoding target image from the bitstream and outputs the decoded decoding target image based on the information decoded by the prediction unit information decoding section 207.

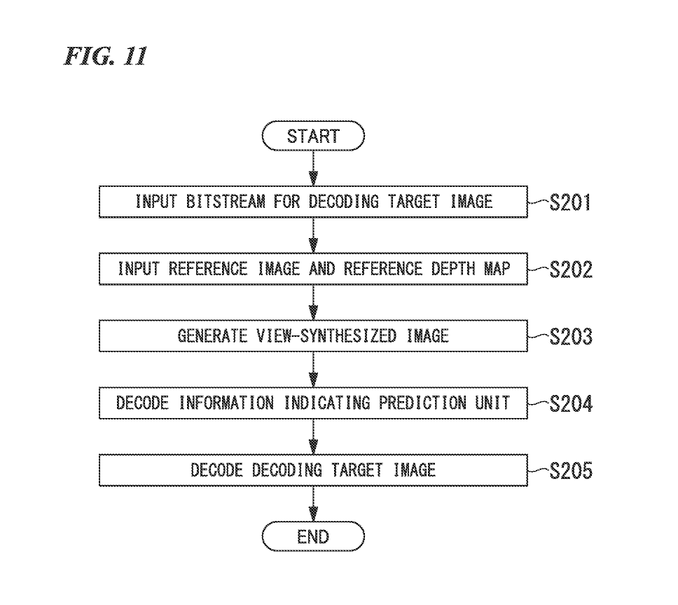

Next, an operation of the image decoding apparatus 200a illustrated in FIG. 10 will be described with reference to FIG. 11. FIG. 11 is a flowchart illustrating the operation of the image decoding apparatus 200a illustrated in FIG. 10. First, the bitstream input section 201 inputs a bitstream obtained by encoding a decoding target image and stores the bitstream in the bitstream memory 202 (step S201). Next, the reference image input section 203 inputs a reference image and the reference depth map input section 204 inputs a reference depth map and outputs the reference depth map to the view-synthesized image generating section 205 (step S202).

Also, the reference image and the reference depth map input in step S202 are assumed to be the same as those used on the encoding side. This is because the occurrence of encoding noise such as a drift is suppressed by using exactly the same information as that obtained by the image encoding apparatus. However, when this occurrence of encoding noise is allowed, content different from content used during encoding may be input. In relation to the reference depth map, a depth map estimated by applying stereo matching or the like to a multiview image decoded for a plurality of cameras, a depth map estimated using a decoded disparity vector or motion vector or the like, and so on may be used in addition to separately decoded content.

Next, the view-synthesized image generating section 205 generates a view-synthesized image Synth for the decoding target image and stores the generated view-synthesized image Synth in the view-synthesized image memory 206 (step S203). The process here is the same as step S103 during the encoding described above. Also, although it is necessary to use the same method as the method used during the encoding so as to suppress the occurrence of encoding noise such as the drift, a method different from that used during the encoding may be used when the occurrence of this encoding noise is allowed.

Next, when the view-synthesized image is obtained, the prediction unit information decoding section 207 decodes information indicating the prediction unit from the bitstream (step S204). For example, when the prediction unit is indicated by one bit of a header of the bitstream for the decoding target image, the prediction unit is determined by reading the one bit.

Next, according to the obtained prediction unit, the image decoding section 208 decodes the decoding target image. The obtained decoding target image becomes an output of the image decoding apparatus 200a. Also when the present invention is used in moving-image decoding, multiview image decoding, or the like, when the decoding target image is used if another frame is decoded, and the like, the decoding target image is stored in a separately defined decoding image memory.

A method corresponding to that used during encoding is used in decoding of a decoding target image. If the bitstream generated by the image encoding apparatus described above is decoded, the decoding is performed by setting the view-synthesized image as an image to be decoded when the prediction of the frame unit is performed. On the other hand, when the prediction of the block unit is performed, the decoding target image is decoded while the predicted image is generated in a designated method for each of the regions (decoding target blocks) into which the decoding target image is divided. For example, when encoding is performed using a scheme based on H.264/AVC disclosed in Non-Patent Literature 1, a decoding target image is decoded by decoding information indicating a prediction method or a predictive residue from a bitstream for every block and adding the predictive residue to the predicted image generated according to the decoded prediction method. Also, when the prediction of the frame unit is performed, the decoding target image is decoded by decoding the predictive residue from the bitstream and adding the decoded predictive residue to the view-synthesized image when the predictive residue has been encoded.

Here, a bitstream for the image signal is input to the image decoding apparatus 200a. That is, a parameter set or header indicating information of an image size or the like is analyzed outside the image decoding apparatus 200a if necessary and the image decoding apparatus 200a is assumed to be notified of information necessary for decoding.

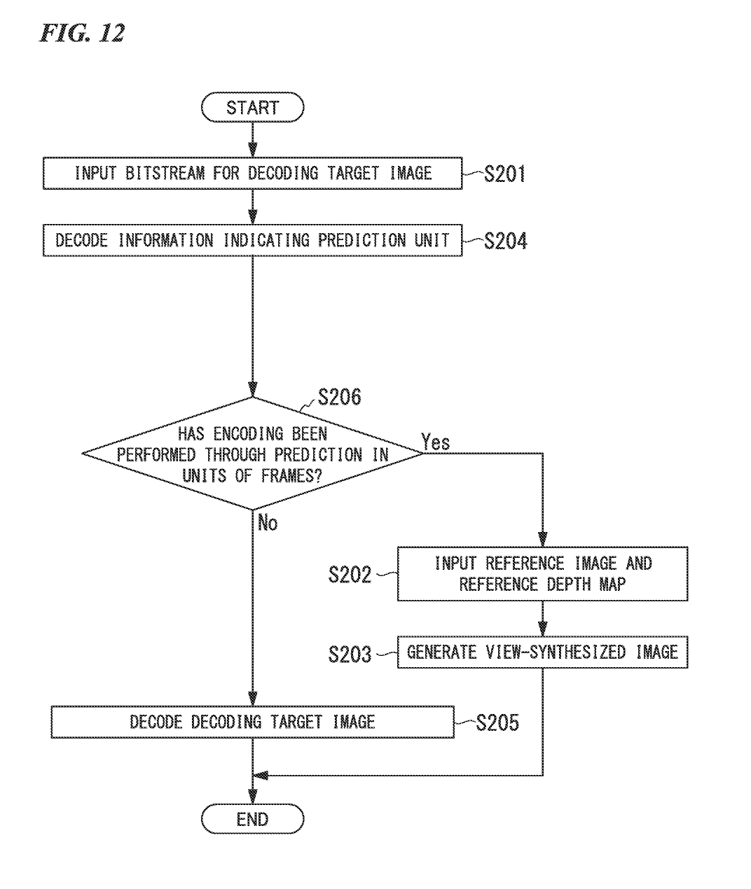

In the above description, a possibility of prediction using the view-synthesized image is assumed when the prediction of the block unit is performed. However, in the case in which the prediction using the view-synthesized image is unlikely to be performed when the prediction of the block unit is performed, the view-synthesized image may be generated if necessary after the prediction unit is decoded. FIG. 12 is a flowchart illustrating a processing operation of generating a view-synthesized image only when the prediction unit is a frame unit. The processing operation illustrated in FIG. 12 is different from the processing operation illustrated in FIG. 11 in that it is determined whether the inputs (step S202) of the reference image and the reference depth map and the generation (step S203) of the view-synthesized image are performed based on a determination of the prediction unit (step S206).

In addition, although the same view-synthesized image is used when the prediction of the frame unit is performed and when the prediction of the block unit is performed in the above-described description, view-synthesized images may be generated in different methods. For example, the memory amount for storing the view-synthesized image may be reduced and the quality of the view-synthesized image may be improved by referring to information of a previously decoded block to perform synthesis when the prediction is performed in units of blocks. In addition, when the prediction is performed in units of frames, qualities of a view-synthesized image and a decoding target image may be improved by performing synthesis in view of the integrity or objective quality in the entire frame.

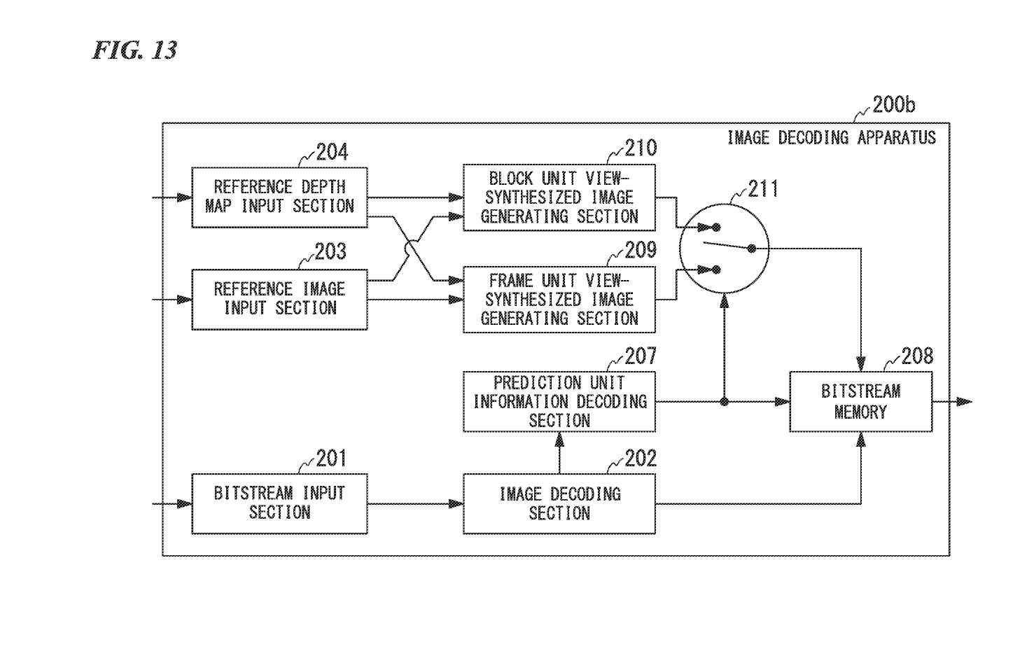

Next, an image decoding apparatus according to the sixth embodiment of the present invention will be described. FIG. 13 is a block diagram illustrating a configuration of the image decoding apparatus when a view-synthesized image is generated in a different method for every prediction unit. The image decoding apparatus 200b illustrated in FIG. 13 is different from the image decoding apparatus 200a illustrated in FIG. 10 is that the image encoding apparatus 200b has two view-synthesized image generating sections including a frame unit view-synthesized image generating section 209 and a block unit view-synthesized image generating section 210 and a switch 211 and the view-synthesized image memory is not necessarily provided. Also, the same components as those of the image decoding apparatus 200a are assigned the same reference signs and description thereof will be omitted.

The frame unit view-synthesized image generating section 209 obtains a corresponding relationship between the pixel of the decoding target image and the pixel of the reference image using the reference depth map and generates the view-synthesized image for the entire decoding target image. The block unit view-synthesized image generating section 210 generates a view-synthesized image for every block on which a process of decoding the decoding target image is performed using the reference depth map. The switch 211 switches the view-synthesized image to be input to the image decoding section 208 according to a prediction unit output by the prediction unit information decoding section 207.

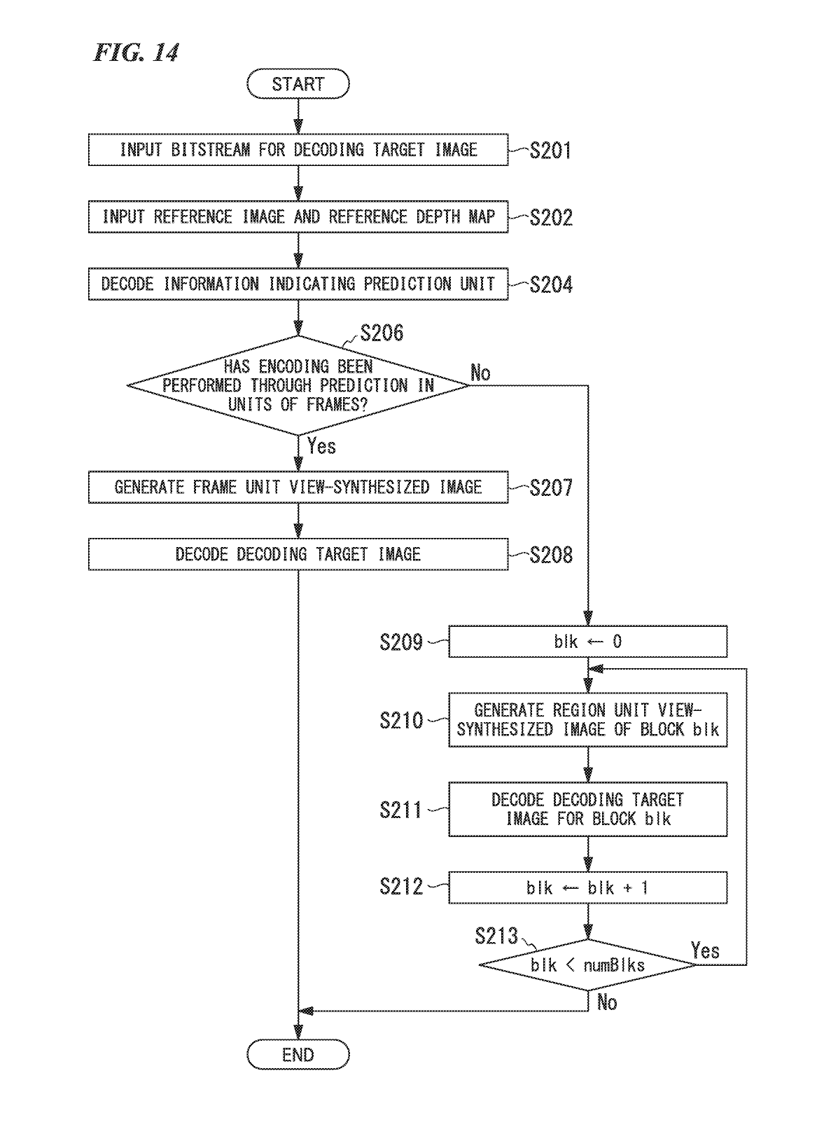

Next, a processing operation of an image decoding apparatus 200b illustrated in FIG. 13 will be described with reference to FIG. 14. FIG. 14 is a flowchart illustrating the processing operation of the image decoding apparatus 200b illustrated in FIG. 13.

The processing operation illustrated in FIG. 14 is different from that illustrated in FIG. 11 or 12 in that the view-synthesized image to be generated is switched according to a prediction unit obtained through decoding (step S206). Also, when the prediction of the block unit is performed, a process of generating the block unit view-synthesized image (step S210) and a process of decoding the decoding target image (step 211) are iterated for every block. In this flowchart, a variable indicating an index for the block to be decoded is indicated by blk and the number of blocks within the decoding target image is indicated by numBlks.

A process of generating the view-synthesized image for the entire frame (step S207) is the same as step S203 described above. In addition, any method as a method for generating the view-synthesized image may be used. For example, a method disclosed in Non-Patent Literature 3 may be used. The process (steps S208 and S211) of decoding the decoding target image is the same as the above-described step S205 except that a different unit is to be processed in addition to a fixed prediction unit.

In the above description, only information indicating the prediction unit is generated for the decoding target image and no prediction information is generated for each block of the decoding target image when the prediction of the frame unit is performed. However, prediction information for each block which is not included in the bitstream may be generated and referenced when another frame is decoded. Here, the prediction information is information to be used in generation of a predicted image or decoding of a predictive residue such as a prediction block size, a prediction mode, or a motion/disparity vector.

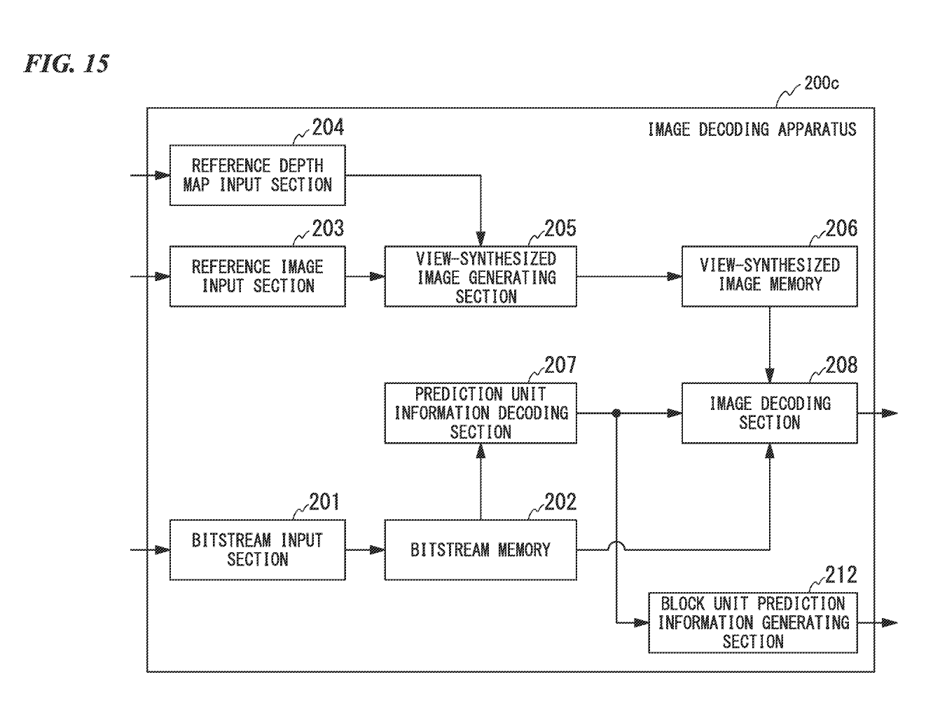

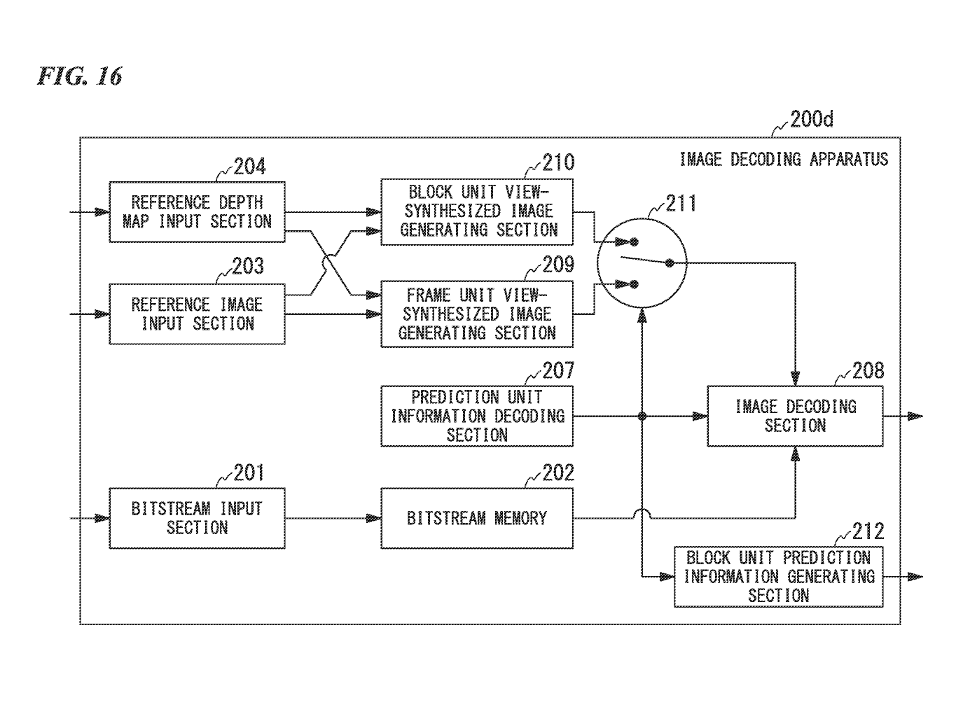

Next, the image decoding apparatuses according to the seventh and eighth embodiments of the present invention will be described with reference to FIGS. 15 and 16. FIGS. 15 and 16 are block diagrams illustrating configurations of image decoding apparatuses in which prediction information is generated for each of the blocks into which a decoding target image can be divided and referenced when another frame is decoded if it is determined that the prediction of the frame unit is performed. In the block diagrams, the image decoding apparatus 200c illustrated in FIG. 15 corresponds to the image decoding apparatus 200a illustrated in FIG. 10 and the image decoding apparatus 200d illustrated in FIG. 16 corresponds to the image decoding apparatus 200b illustrated in FIG. 13. A difference in each block diagram is that a block unit prediction information generating section 212 is further included. Also, the same components are assigned the same reference signs and description thereof will be omitted.

When it is determined that the prediction of the frame unit is performed, the block unit prediction information generating section 212 generates prediction information for each of the blocks into which the decoding target image is divided and outputs the generated prediction information to the image decoding apparatus for decoding another frame. Also, when another frame is decoded in the same image decoding apparatus, the generated information is passed to the image decoding section 208.

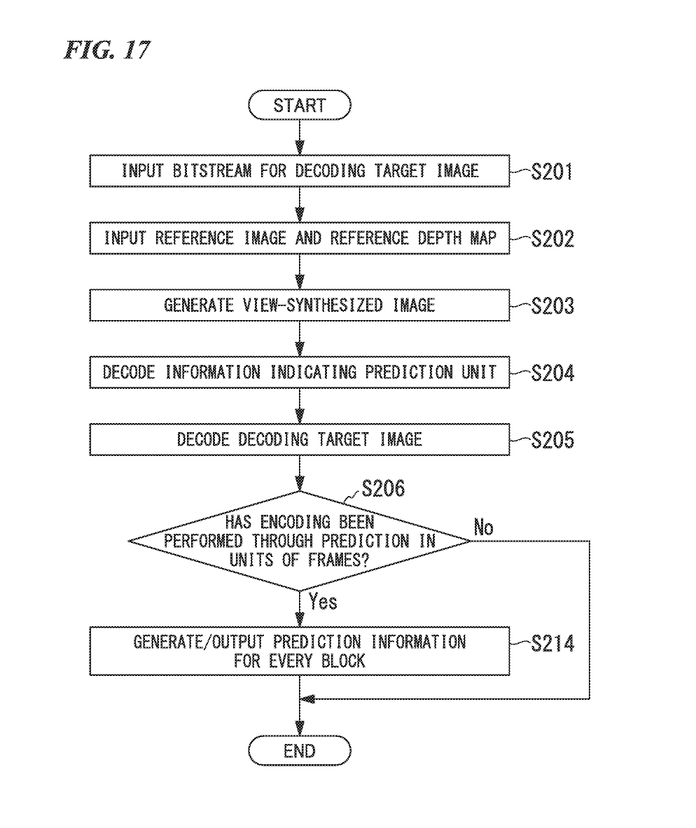

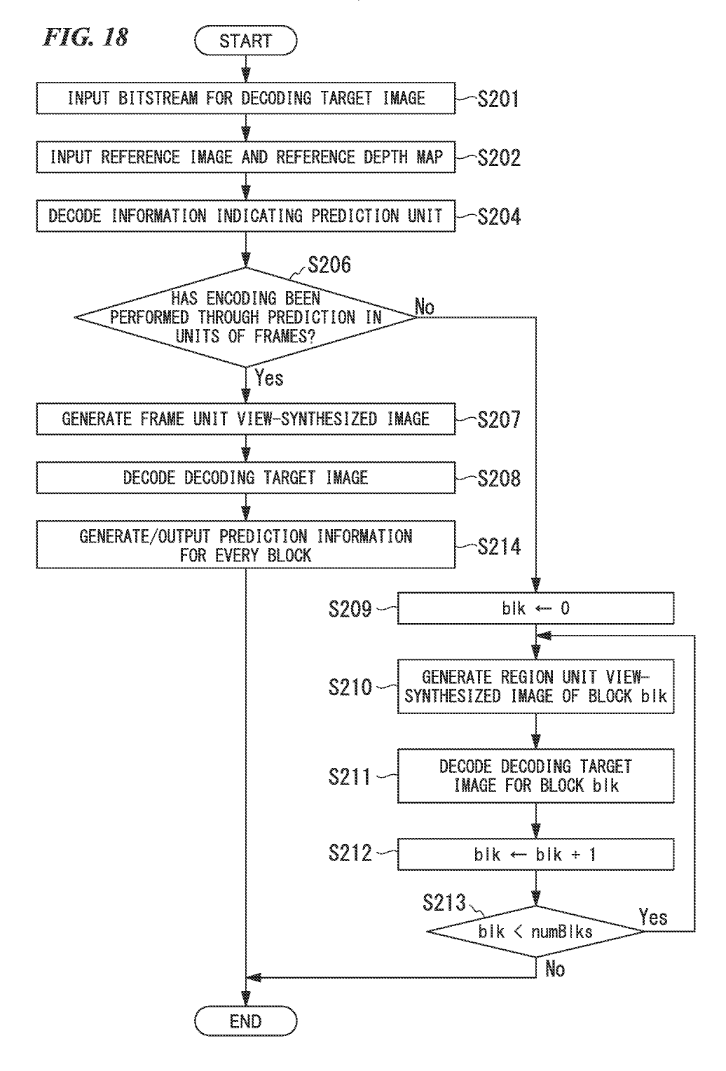

Next, processing operations of the image decoding apparatus 200c and the image decoding apparatus 200d illustrated in FIGS. 15 and 16 will be described with reference to FIGS. 17 and 18. FIGS. 17 and 18 are flowcharts illustrating the processing operations of the image decoding apparatus 200c illustrated in FIG. 15 and the image decoding apparatus 200d illustrated in FIG. 16. Because the basic process is the same as the processing operations illustrated in FIGS. 11 and 14, the steps of performing the same processes as described above are assigned the same reference signs and description thereof will be omitted.

In this case, as a specific process, a process (step S214) of generating/outputting prediction information for every block is added when the prediction unit is a frame unit. Also, as long as the prediction information is the same as that generated on the encoding side, any information may be generated in the generation of the prediction information. For example, a block size as large as possible or a block size as small as possible may be designated as a prediction block size. In addition, a different block size may be set for every block by making a determination based on the used depth map or the generated view-synthesized image. The block size may be adaptively determined so that a set of pixels as large as possible is provided, wherein the pixels have similar pixel values or depth values.

As the prediction mode or the motion/disparity vector, the mode information or motion/disparity vector indicating the prediction using the view-synthesized image may be set when the prediction is performed for every block with respect to all blocks. In addition, the mode information corresponding to an inter-view prediction mode and the disparity vector obtained from a depth or the like may be set as the mode information and the motion/disparity vector, respectively. The disparity vector may be obtained by performing a search on a reference image using the view-synthesized image for the block as a template.

As another method, an optimum block size or prediction mode may be estimated and generated by regarding the view-synthesized image as the encoding target image and analyzing the view-synthesized image. In this case, intra-picture prediction, motion-compensated prediction, or the like may be selected as the prediction mode.

In this manner, information which is not obtained from the bitstream can be generated and referenced when another frame is decoded, so that it is possible to improve coding efficiency in another frame. This is because there are correlations even in motion vectors or prediction modes when similar frames such as temporally continuous frames or frames obtained by photographing the same object are encoded and redundancy can be removed using these correlations.

Although a process of encoding and decoding one frame has been described above, this technique is also applicable to moving-image encoding by iterating the process for a plurality of frames. In addition, this technique is applicable to only a frame or a block of part of a moving image. For example, the process may be applied to only some regions referred to as tiles or slices obtained by dividing a frame. In addition, the process may be applied to a part or the entirety of a field defined in an interlaced image or the like. Further, although the configurations and the processing operations of the image encoding apparatus and the image decoding apparatus have been described above, it is possible to implement an image encoding method and an image decoding method of the present invention through processing operations corresponding to operations of the sections of the image encoding apparatus and the image decoding apparatus.

In addition, although an example in which the reference depth map is a depth map for an image captured by a camera different from an encoding target camera or a decoding target camera has been described above, a depth map for an image captured by the encoding target camera or the decoding target camera at a different time from the encoding target image or the decoding target image may be used as the reference depth map.

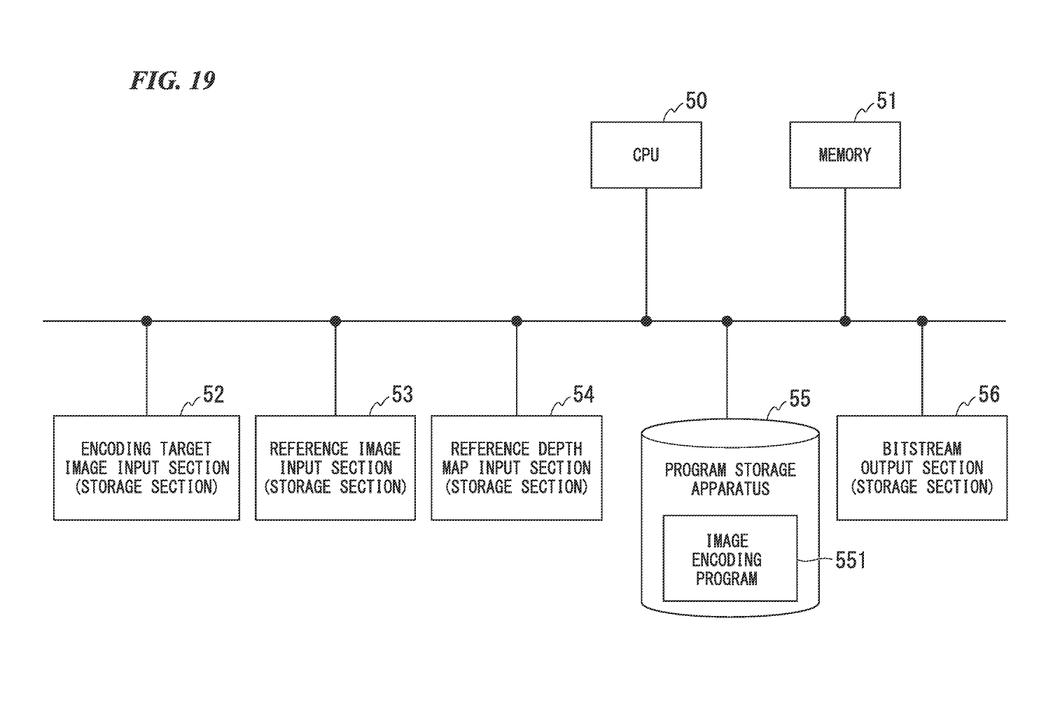

FIG. 19 is block diagram illustrating a hardware configuration when the above-described image encoding apparatus 100 is constituted of a computer and a software program. The system illustrated in FIG. 19 has a configuration in which a central processing unit (CPU) 50 configured to execute the program, a memory 51 such as a random access memory (RAM), an encoding target image input section 52, a reference image input section 53, a reference depth map input section 54, a program storage apparatus 55, and a bitstream output section 56 are connected through a bus. The CPU 50 executes the program. The memory 51 such as the RAM stores the program and data to be accessed by the CPU 50. The encoding target image input section 52 inputs an image signal of an encoding target from a camera or the like (the encoding target image input section 52 may be a storage section such as a disc apparatus configured to store an image signal). The reference image input section 53 inputs an image signal of a reference target from a camera or the like (the reference image input section 53 may be a storage section such as a disc apparatus configured to store an image signal). The reference depth map input section 54 inputs a depth map for a camera of a different position or direction from the camera capturing the encoding target image from a depth camera or the like (the reference depth map input section 54 may be a storage section such as a disc apparatus configured to store the depth map). The program storage apparatus 55 stores an image encoding program 551 which is a software program for causing the CPU 50 to execute the above-described image encoding process. The bitstream output section 56 outputs a bitstream generated by executing the image encoding program 551 loaded to the memory 51 by the CPU 50, for example, via a network (the bitstream output section 56 may be a storage section such as a disc apparatus configured to store the bitstream).

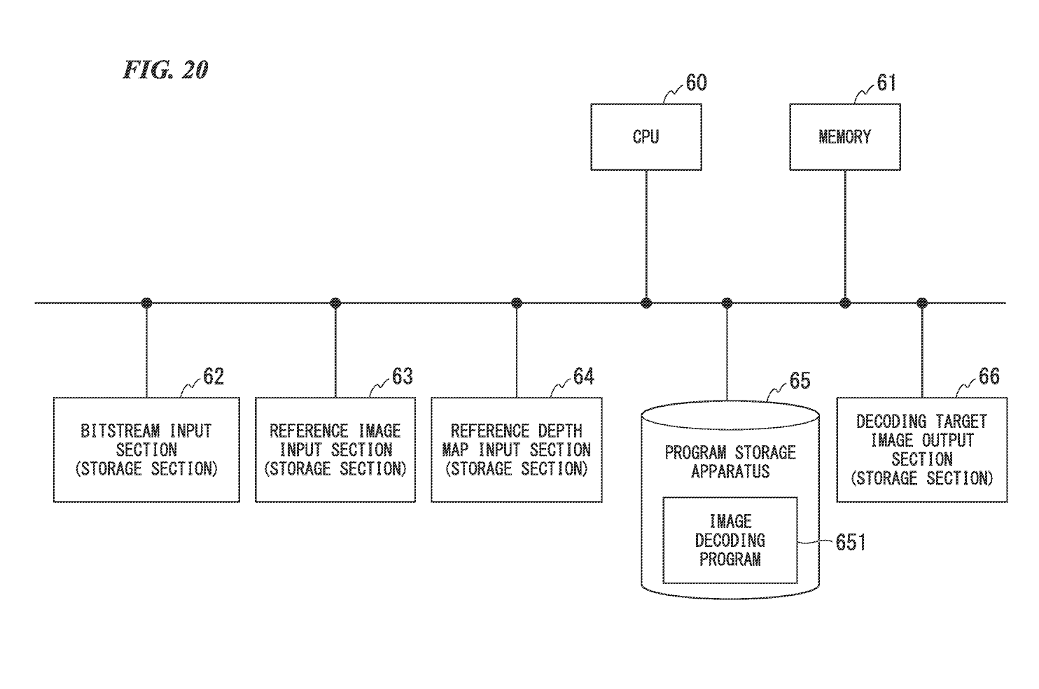

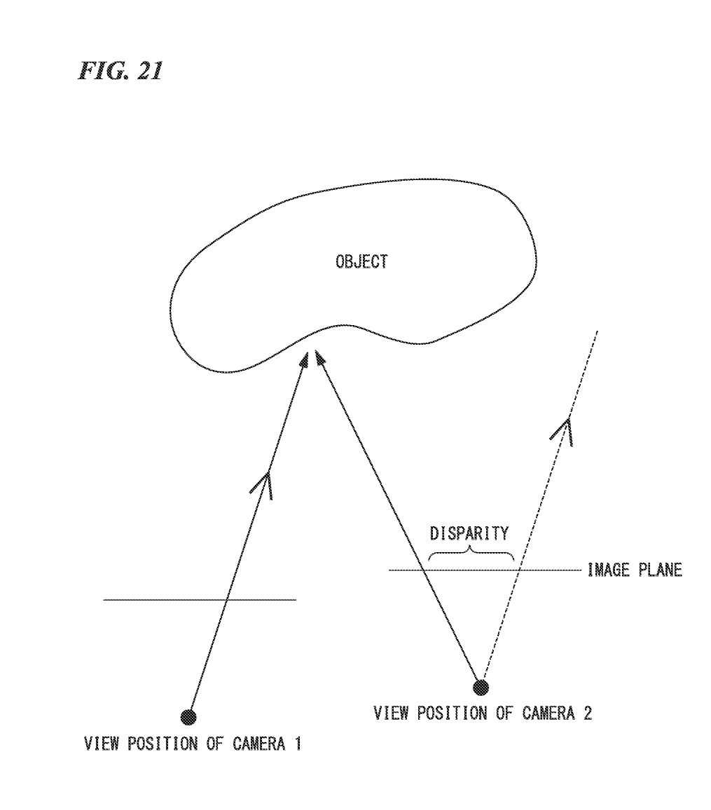

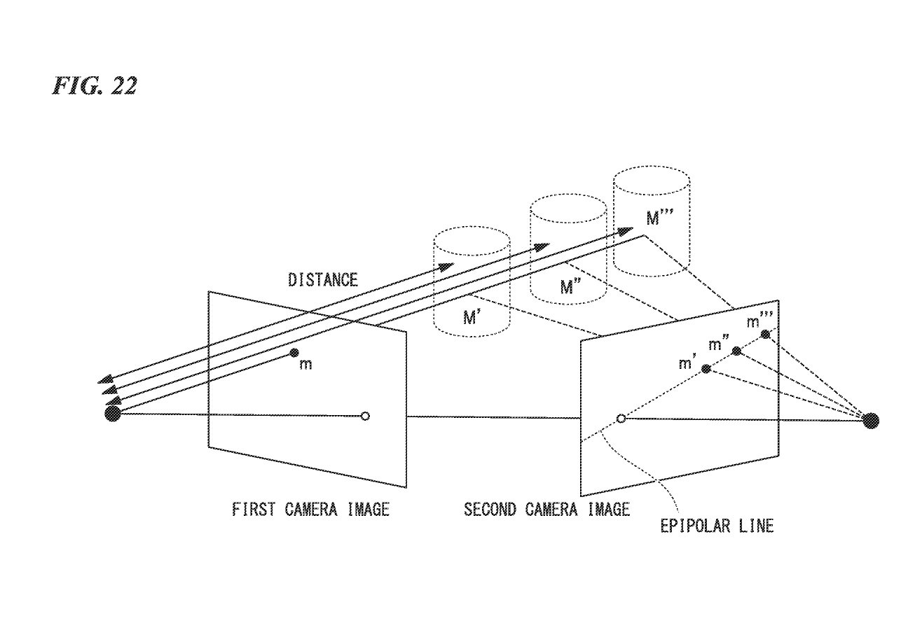

FIG. 20 is a block diagram illustrating a hardware configuration when the above-described image decoding apparatus 200 is constituted of a computer and a software program. The system illustrated in FIG. 20 has a configuration in which a CPU 60, a memory 61 such as a RAM, a bitstream input section 62, a reference image input section 63, a reference depth map input section 64, a program storage apparatus 65, and a decoding target image output section 66 are connected through a bus.

The CPU 60 executes the program. The memory 61 such as the RAM stores the program and data to be accessed by the CPU 60. The bitstream input section 62 inputs a bitstream encoded by the image encoding apparatus according to this technique (the bitstream input section 62 may be a storage section such as a disc apparatus configured to store an image signal). The reference image input section 63 inputs an image signal of a reference target from a camera or the like (the reference image input section 63 may be a storage section such as a disc apparatus configured to store an image signal). The reference depth map input section 64 inputs a depth map for a camera of a different position or direction from the camera capturing the decoding target from a depth camera or the like (the reference depth map input section 64 may be a storage section such as a disc apparatus configured to store the depth information). The program storage apparatus 65 stores an image decoding program 651 which is a software program for causing the CPU 60 to execute the above-described image decoding process. The decoding target image output section 66 outputs a decoding target image obtained by decoding the bitstream to a reproduction apparatus or the like by executing the image decoding program 651 loaded to the memory 61 by the CPU 60 (the decoding target image output section 66 may be a storage section such as a disc apparatus configured to store the image signal).

The image encoding apparatus 100 and the image decoding apparatus 200 in the above-described embodiment may be implemented by a computer. In this case, functions of the image encoding apparatus 100 and the image decoding apparatus 200 may be executed by recording a program for implementing the functions on a computer-readable recording medium and causing a computer system to read and execute the program recorded on the recording medium. Also, the “computer system” used here is assumed to include an operating system (OS) and hardware such as peripheral devices. In addition, the “computer-readable recording medium” refers to a storage apparatus including a flexible disk, a magneto-optical disc, a read only memory (ROM), or a portable medium such as a compact disc (CD)-ROM, and a hard disk embedded in the computer system. Further, the “computer-readable recording medium” is assumed to include a computer-readable recording medium for dynamically holding a program for a short time as in a communication line when the program is transmitted via a network such as the Internet or a communication circuit such as a telephone circuit and a computer-readable recording medium for holding the program for a predetermined time as in a volatile memory inside the computer system including a server and a client when the program is transmitted. In addition, the above-described program may be used to implement some of the above-described functions. Further, the program may implement the above-described functions in combination with a program already recorded on the computer system or using hardware such as a programmable logic device (PLD) or a field programmable gate array (FPGA).

While embodiments of the invention have been described above with reference to the drawings, it should be understood that these are exemplary of the invention and are not to be considered as limiting. Accordingly, additions, omissions, substitutions, and other modifications of constituent elements may be made without departing from the spirit or scope of the present invention.

### INDUSTRIAL APPLICABILITY

The present invention is applicable for essential use in achieving high coding efficiency without increasing a calculation amount and memory usage during decoding when view-synthesized prediction is performed on an encoding (decoding) target image using an image captured from a different position from a camera capturing an encoding (decoding) target image and a depth map for an object of the image.

### DESCRIPTION OF REFERENCE SYMBOLS

101 Encoding target image input section
102 Encoding target image memory
103 Reference image input section
104 Reference depth map input section
105 View-synthesized image generating section
106 View-synthesized image memory
107 Frame unit prediction RD cost calculating section
108 Image encoding section
109 Block unit prediction RD cost calculating section
110 Prediction unit determining section
111 Bitstream generating section
112 Reference image memory
113 Reference depth map memory
114 Frame unit view-synthesized image generating section
115 Block unit view-synthesized image generating section
116 Block unit prediction information generating section
201 Bitstream input section
202 Bitstream memory
203 Reference image input section
204 Reference depth map input section
205 View-synthesized image generating section
206 View-synthesized image memory
207 Prediction unit information decoding section
208 Image decoding section
209 Frame unit view-synthesized image generating section
211 Switch
212 Block unit prediction information generating section

1. An image encoding apparatus for performing encoding while predicting an image between different views using a reference image encoded for a different view from an encoding target image and a reference depth map for an object of the reference image when a multiview image including images of a plurality of different views is encoded, the image encoding apparatus comprising:
a view-synthesized image generating section configured to generate a view-synthesized image for the entire encoding target image using the reference image and the reference depth map;
a prediction unit setting section configured to select whether to perform prediction for each of encoding target blocks into which the encoding target image is divided as a prediction unit or whether to perform prediction using the view-synthesized image for the entire encoding target image as the prediction unit;
a prediction unit information encoding section configured to encode information indicating the selected prediction unit; and
a predictive encoding target image encoding section configured to perform predictive encoding on the encoding target image for every encoding target block while selecting a predicted image generation method when the prediction for every encoding target block as the prediction unit has been selected.

2. The image encoding apparatus according to claim 1, further comprising:
a view-synthesized predictive residue encoding section configured to encode a difference between the encoding target image and the view-synthesized image when the prediction using the view-synthesized image for the entire encoding target image as the prediction unit has been selected.

3. The image encoding apparatus according to claim 1, further comprising:
an image unit prediction rate distortion (RD) cost estimating section configured to estimate an image unit prediction RD cost which is an RD cost when the entire encoding target image is predicted by the view-synthesized image and encoded; and
a block unit prediction RD cost estimating section configured to estimate a block unit prediction RD cost which is an RD cost when the predictive encoding is performed on the encoding target image while selecting the predicted image generation method for every encoding target block,
wherein the prediction unit setting section compares the image unit prediction RD cost with the block unit prediction RD cost to set the prediction unit.

4. The image encoding apparatus according to claim 1, further comprising:
a partial view-synthesized image generating section configured to generate a partial view-synthesized image which is a view-synthesized image for the encoding target block using the reference image and the reference depth map for every encoding target block,
wherein the predictive encoding target image encoding section uses the partial view-synthesized image as a candidate for a predicted image.

5. The image encoding apparatus according to claim 1, further comprising:
a prediction information generating section configured to generate prediction information for every encoding target block when the prediction using the view-synthesized image for the entire image as the prediction unit has been selected.

6. The image encoding apparatus according to claim 5,
wherein the prediction information generating section determines a prediction block size, and
wherein the view-synthesized image generating section generates the view-synthesized image for the entire encoding target image by iterating a process of generating the view-synthesized image for every prediction block size.

7. The image encoding apparatus according to claim 5, wherein the prediction information generating section estimates a disparity vector and generates prediction information as disparity-compensated prediction.

8. The image encoding apparatus according to claim 5, wherein the prediction information generating section determines a prediction method and generates prediction information for the prediction method.

9. An image decoding apparatus for performing decoding while predicting an image between different views using a reference image decoded for a different view from the decoding target image and a reference depth map for an object of the reference image when the decoding target image is decoded from encoded data of a multiview image including images of a plurality of different views, the image decoding apparatus comprising:
a view-synthesized image generating section configured to generate a view-synthesized image for the entire decoding target image using the reference image and the reference depth map;
a prediction unit information decoding section configured to decode information about a prediction unit indicating whether to perform prediction for each of decoding target blocks into which the decoding target image has been divided, or whether to perform prediction using the view-synthesized image for the entire decoding target image, from the encoded data;
a decoding target image setting section configured to set the view-synthesized image as the decoding target image when the information about the prediction unit indicates that the prediction is performed using the view-synthesized image for the entire decoding target image; and
a decoding target image decoding section configured to decode the decoding target image from the encoded data while generating a predicted image for every decoding target block when the information about the prediction unit indicates that the prediction is performed for every decoding target block.

10. The image decoding apparatus according to claim 9, wherein the decoding target image setting section decodes a difference between the decoding target image and the view-synthesized image from the encoded data and generates the decoding target image by adding the difference to the view-synthesized image.

11. The image decoding apparatus according to claim 9, further comprising:
a partial view-synthesized image generating section configured to generate a partial view-synthesized image which is a view-synthesized image for the decoding target block using the reference image and the reference depth map for every decoding target block,
wherein the decoding target image decoding section uses the partial view-synthesized image as a candidate for a predicted image.

12. The image decoding apparatus according to claim 9, further comprising:
a prediction information generating section configured to generate prediction information for every decoding target block when the information about the prediction unit indicates that the prediction is performed using the view-synthesized image for the entire decoding image.

13. The image decoding apparatus according to claim 12,
wherein the prediction information generating section determines a prediction block size, and
wherein the view-synthesized image generating section generates the view-synthesized image for the entire decoding target image by iterating a process of generating the view-synthesized image for every prediction block size.

14. The image decoding apparatus according to claim 12, wherein the prediction information generating section estimates a disparity vector and generates prediction information as disparity-compensated prediction.

15. The image decoding apparatus according to claim 12, wherein the prediction information generating section determines a prediction method and generates prediction information for the prediction method.

16. An image encoding method of performing encoding while predicting an image between different views using a reference image encoded for a different view from an encoding target image and a reference depth map for an object of the reference image when a multiview image including images of a plurality of different views is encoded, the image encoding method comprising:
a view-synthesized image generating step of generating a view-synthesized image for the entire encoding target image using the reference image and the reference depth map;
a prediction unit setting step of selecting whether to perform prediction for each of encoding target blocks into which the encoding target image is divided as a prediction unit or whether to perform prediction using the view-synthesized image for the entire encoding target image as the prediction unit;
a prediction unit information encoding step of encoding information indicating the selected prediction unit; and
a predictive encoding target image encoding step of performing predictive encoding on the encoding target image for every encoding target block while selecting a predicted image generation method when the prediction for every encoding target block as the prediction unit has been selected.

17. An image decoding method of performing decoding while predicting an image between different views using a reference image decoded for a different view from the decoding target image and a reference depth map for an object of the reference image when the decoding target image is decoded from encoded data of a multiview image including images of a plurality of different views, the image decoding method comprising:
a view-synthesized image generating step of generating a view-synthesized image for the entire decoding target image using the reference image and the reference depth map;
a prediction unit information decoding step of decoding information about a prediction unit indicating whether to perform prediction for each of decoding target blocks into which the decoding target image has been divided, or whether to perform prediction using the view-synthesized image for the entire decoding target image, from the encoded data;
a decoding target image setting step of setting the view-synthesized image as the decoding target image when the information about the prediction unit indicates that the prediction is performed using the view-synthesized image for the entire decoding target image; and
a decoding target image decoding step of decoding the decoding target image from the encoded data while generating a predicted image for every decoding target block when the information about the prediction unit indicates that the prediction is performed for every decoding target block.

18. A non-transitory computer readable storage medium which stores an image encoding program for causing a computer to execute the image encoding method according to claim 16.

19. A non-transitory computer readable storage medium which stores an image decoding program for causing a computer to execute the image decoding method according to claim 17.
